(19) United States
(12) Patent Application Publication
(10) Pub. No.: US 2023/0360110 A1
(43) Pub. Date: Nov. 9, 2023

(54) SYSTEM AND METHOD FOR FACILITATING COORDINATION OF DRIVE UP ORDER FULFILLMENT

(71) Applicant: Target Brands, Inc., Minneapolis, MN (US)

(72) Inventors: Andria Rambow, Minneapolis, MN (US); Syed G. H. Mohammed, Minneapolis, MN (US); Slade Baumann, Minneapolis, MN (US); David Perich, Minneapolis, MN (US)

(21) Appl. No.: 18/143,346

(22) Filed: May 4, 2023

Related U.S. Application Data
(60) Provisional application No. 63/338,254, filed on May 4, 2022.

(51) Int. Cl. G06Q 30/0601

(52) U.S. Cl. CPC G06Q 30/0635; G06Q 30/0641

(57) ABSTRACT

A method can include providing, by a computing system to a group of user devices, information to display a first graphical user interface (GUI) including a list of customer orders for fulfillment, receiving, from a first user device, selection of a control to prepare an order in the list, providing, to a subset of the group, instructions to update the first GUI to include an indication that the order is being prepared, providing, at the first user device, information to display a second GUI including indications of order hold locations and bags associated with the locations for the selected order, and receiving, from the first user device, identifying information for the bags, providing, to the first user device, instructions to update the second GUI such that the bag indications are updated from a first indicia to a second indicia.

### CROSS-REFERENCE TO RELATED APPLICATIONS

This application claims the benefit of U.S. Patent Application Ser. No. 63/338,254, filed on May 4, 2022. The disclosure of the prior application is considered part of (and is incorporated by reference in) the disclosure of this application.

### TECHNICAL FIELD

This document generally relates to architecture of computer systems, communications between computing devices, and graphic user interfaces for eliciting user input.

### BACKGROUND

Computing devices are devices that accept data input, process the data, and provide data output using hardware and software. Computing devices can communicate with other computing devices using wired or wireless networks or a combination thereof. For example, computing devices can communicate over the Internet. User interactions with a computing device can cause the computing device to transmit communications to a second computing device, which can cause the second computing device to provide output such as changes to a visual display, sounds, or tactile output. Such output at the second computing device can elicit user input from a user of the second computing device, which can in turn cause the second computing device to transmit one or more communications to the first computing device thereby causing the first computing device to generate additional output.

### SUMMARY

This document generally describes a network based order fulfillment system that provides information to one or more user devices that allow users of the user devices located at a fulfillment location (such as a physical store location, a restaurant, a warehouse, or other location) to fulfill orders placed by users of other user devices. For example, the disclosed techniques provide for coordinating efforts between users, such as store employees, to fulfill drive-up and/or pickup orders at the fulfillment location. In general fulfilling orders can include preparing, staging, and delivering the orders to customers at the fulfillment location. The users can prepare the orders out of hold locations in the fulfillment location. The hold locations can include, but are not limited to, refrigerated, frozen, and non-refrigerated areas. The users can view information at their mobile user devices about orders to be fulfilled. For example, they can view indications about how many customers are on their way to the fulfillment location and how many customers have arrived, which can help the users prioritize preparation, staging, and delivery of the orders. The users can select indications presented at their user devices to claim preparation stage for orders, which can make the other users aware that a particular order is being taken care of. In some implementations, a user can cancel preparation of an order they claimed and/or an order that another user claimed. When a user prepares an order, they can scan bags of items out of hold locations in the fulfillment location. With each scan, an indication per bag presented at the user device can be updated to reflect that the bag was successfully scanned. Once the user has scanned all the bags for the order, the order is no longer being prepared and is ready to be delivered to the customer upon their arrival at the fulfillment location.

More particularly, a user device of each user can display graphical user interfaces (GUIs) of yet to be fulfilled orders. These orders can be ranked by priority (e.g., order and/or ETA). One or more icons presented in the GUI may also be displayed with each order to indicate a stage of preparation and/or delivery of that order. For example, these icons can include, but are not limited to, “Not yet started,” “In hold,” and “Guest ready.” Each icon can also indicate how many total orders are at each stage of preparation. The users can select various icons presented in the GUI to view a list of orders categorized in each stage. Then, the users can select individual orders to view a display of additional details about the order.

Using the disclosed techniques, the users can take ownership of arrived orders by selecting a control, such as a selectable button, to prepare an order. Selecting this control can cause a GUI presented at the other user devices to update and indicate that the particular order is now being prepared. As a result, the users can become aware, in real or near real time, when someone in the fulfillment location has already started working on the order. Sometimes, when a user takes ownership of an order, an icon or other graphical element can be displayed with that order on the user devices of the other users. This icon or graphical element can include an identifier for the user that took responsibility of preparing the order.

When the user selects the order to prepare, a GUI can be presented at the user's device that depicts a number of bags and number of items in each bag to be prepared for the order. The GUI can also show a hold location for each bag (in some implementations, different bags for the same order may be in different hold locations). The user can select a displayed bag to a see list of items for that bag so that they can verify the correct items are in a bag for the selected order. The team member then can scan the bag out of the holding location to prepare the order. As bags are scanned, the graphical elements in the GUI can be updating to show which bags have been scanned and which have not yet been scanned. Once all the bags for the selected order have been scanned, the user can select an option presented at the GUI to move the order to a tab for “Guest ready” orders. The user can return navigate to a GUI that presents the “Guest ready” orders, in some implementations. Once a prepared order is in the “Guest ready” tab, the same user or a different user can select a control, such as a button, to take ownership of delivering the order to a particular customer.

The disclosed techniques can provide for users to cancel orders and/or cancel items in orders when they are being prepared. Moreover, customers may cancel items from orders that already may be in a hold location and thus presented in an “In Hold” tab at the user devices. In such a scenario, when a user scans a bag with a cancelled item while preparing that order, a notification can be presented at the user device indicating that the cancelled item should be removed from the scanned bag. The GUI on the user's device may also include an indicator, such as an orange triangle or hazard symbol, on a graphical element representing the bag to indicate to the user that there is one or more cancelled items in that bag.

One or more embodiments described herein can include a method including: providing, by a computing system to each of a group of user devices, information that, when processed by each of the group of user devices, causes each of the group of user devices to display a first graphical user interface (GUI), the first GUI including a list of orders for customers for fulfillment at a fulfillment location, receiving, by the computing system and from a first user device of the group of user devices, user selection of a first control in the first GUI indicating an intention to prepare an order in the list of orders, providing, by the computing system to at least a subset of the group of user devices, instructions to update the first GUI such that the first GUI includes an indication that the order is being prepared, providing, by the computing system at the first user device in the group of user devices, information that, when processed by the first user device cause the first user device to display a second GUI, the second GUI including indications of one or more order hold locations in the retail information and one or more bags associated with each of the one or more order hold locations for the selected order to be prepared, receiving, by the computing system and from the first user device, information indicating identifying information for one or more of the bags associated with the order, providing, by the computing system to the first user device, instructions to update the second GUI such that, for each bag associated with the order to be prepared, the indication is updated from a first indicia to a second indicia based on the respective associated bag having been identified by the identifying information and received by the computing system, and providing, by the computing system to the first user device, instructions to update the second GUI to include a selectable option to complete the preparing of the order based on a determination that the identifying information for each bag associated with the order has been received by the computing system.

In some implementations, the embodiments described herein can optionally include one or more of the following features. For example, the first indicia can be a black bag icon and the second indicia can be a green bag icon. The indication that the order is being prepared can include an identifier of a user associated with the first user device. The method can also include receiving, by the computing system and from the first user device, an indication of selecting the option to complete the preparing of the order, and providing, by the computing system to at least the subset of the group of user devices, instructions to update the first GUI by removing the order from the list of orders and adding the order to a second list of orders ready to be delivered. The method can also include providing, by the computing system to each of at least the subset of the group of user devices, information that, when processed by each of the at least the subset of the group of user devices, causes each of the at least the subset of the group of user devices to display the first GUI with a list of orders ready to be delivered, receiving, by the computing system and from a second user device of the at least the subset of the group of user devices, an indication of user selection of a second control of the first GUI indicating an intention to deliver a prepared order in the list of orders ready to be delivered, and providing, by the computing system to each of at least the subset of the group of user devices, instructions to update the first GUI to include an indication that the prepared order is being delivered. The indication that the prepared order is being delivered can include an identifier for a user associated with the second user device.

In some implementations, the method can also include receiving, by the computing system and from the first user device, an indication of user selection of a third control of the first GUI to cancel the preparing of the order, and providing, by the computing system to the at least the subset of the group of user devices, instructions to update the first GUI by replacing the third control to cancel the preparing of the order with the first control to prepare the order. In some implementations, the indications of each bag can include a numeric value graphically displayed in a bag icon, the numeric value indicating a quantity of items in the bag. As another example, the method can also include receiving, by the computing system and from the first user device, an indication of user selection of an indication of a bag of the one or more bags presented in the second GUI, providing, by the computing system to the first user device, information that, when processed by the first device, causes the first device to display a pop out window that overlays a portion of the second GUI, the pop out window including information about items in the selected bag, the information including selectable options for completing a hold on the selected bag, receiving, by the computing system and from the first user device, an indication of user selection of an option from the selectable options to complete the hold on the selected bag, and providing, by the computing system to the first user device, information that, when processed by the first device, causes the first device to display the selectable option to complete the preparing of the order in the second GUI based on the user selection of the option to complete the hold on the selected bag.

As another example, the method can also include providing, by the computing system to the first user device, information that, when processed by the first user device, causes the first user device to display a third indicia partially overlaying an indication of a bag of the one or more bags based on a determination, by the computing system, that an issue exists with an item in the bag. The issue can include at least one of the item being cancelled and the item being recalled. The third indicia can be at least one of hazard symbol, a triangle, and an exclamation point.

In some implementations, orders in the list of orders for customers for fulfillment at the fulfillment location can be ranked and presented in the first GUI from least amount of time remaining before arrival at the fulfillment location to most amount of time remaining before arrival at the fulfillment location. The list of orders for customers for fulfillment at the fulfillment location can include a first sub-list of at least one order in the list of orders for customers that arrived at the fulfillment location and a second sub-list of at least one order in the list of orders for customers that are on their way to the fulfillment location. The information indicating identifying information for one or more of the bags associated with the order can include indications for the one or more of the bags that are scanned by the first user device at the fulfillment location. The selectable option to complete the preparing of the order can be presented in the second GUI and non-selectable until each bag has been scanned. The information indicating identifying information for one or more of the bags associated with the order can include indications for the one or more of the bags that are scanned by a scanning device communicably coupled to the first user device at the fulfillment location. The information indicating identifying information for one or more of the bags associated with the order can also include indications for the one or more of the bags that are scanned by a scanning device located at the fulfillment location. The information indicating identifying information for one or more of the bags associated with the order can include alphanumeric identifiers for the one or more of the bags that are inputted by a user at the first user device at the fulfillment location.

One or more embodiments described herein can include a system having: one or more processors and computer memory containing instructions that, when executed by the one or more processors, cause the system to perform operations including: providing, to each of a group of user devices, information that, when processed by each of the group of user devices, causes each of the group of user devices to display a first graphical user interface (GUI), the first GUI including a list of orders for customers for fulfillment at a fulfillment location, receiving, from a first user device of the group of user devices, user selection of a first control in the first GUI indicating an intention to prepare an order in the list of orders, providing, to at least a subset of the group of user devices, instructions to update the first GUI such that the first GUI includes an indication that the order is being prepared, providing, at the first user device in the group of user devices, information that, when processed by the first user device cause the first user device to display a second GUI, the second GUI including indications of one or more order hold locations in the retail information and one or more bags associated with each of the one or more order hold locations for the selected order to be prepared, receiving, from the first user device, information indicating identifying information for one or more of the bags associated with the order, providing, to the first user device, instructions to update the second GUI such that, for each bag associated with the order to be prepared, the indication is updated from a first indicia to a second indicia based on the respective associated bag having been identified by the identifying information and received by the computing system, and providing, to the first user device, instructions to update the second GUI to include a selectable option to complete the preparing of the order based on a determination that the identifying information for each bag associated with the order has been received by the computing system.

In some implementations, the system can optionally include one or more of the abovementioned features.

The devices, system, and techniques described herein may provide one or more of the following advantages. For example, the disclosed techniques provide for dynamically updating information presented at user devices of the users in the fulfillment location such that the users can be aware of the status of order fulfillment activities. Information can be updated at the user devices in real or near real time, so that order fulfillment activities can be efficiently claimed by the users. This can increase efficiency in order fulfillment and can prevent or otherwise mitigate potential that more than one user will try to prepare and/or claim an order to be fulfilled at the same time. As a result, orders can be completed more efficiently and on time so that customers may arrive at the fulfillment location and not wait for extended periods of time while their orders are being prepared, staged, and/or delivered. An overall customer experience may be improved.

The disclosed techniques also provide intuitive and user friendly controls, visual indications, and graphical elements to facilitate efficient fulfillment of orders by the users. For example, hazard and other warning signs can appear in some GUIs to bring the user's attention to a potential issue (e.g., item cancellation) when preparing an order. Various GUIs can be automatically updated in response to user input received at the user's computing device or in response to communications from other computing devices to ensure that the most important information is visually communicated to the user in an efficient manner. As a result, the user can quickly and efficiently address potential issues without compromising the customer experience and/or greatly reducing efficiency of order fulfillment activities. The improved GUIs and automatic updating of the GUIs in response to outside information (including communications between computing devices) increase information comprehension of users, thereby improving efficiency of the system. As another example, an option to complete a prepared order and move that order to the “Guest ready” tab may not be selectable by the user until all bags have been scanned for the order and all indications of the bags in the GUI have been updated accordingly. Therefore, the user may not prematurely mark the order as complete and ready to be delivered to the customer. This can improve the customer experience and ensure that fulfillment activities are properly, accurately, and efficiently completed.

As another example, by providing streamlined communications between mobile user devices operated by customers and the users working at fulfillment locations, an order fulfillment system can reduce the amount of time spent interacting with the mobile devices, thereby reducing power consumption and improving battery life of the computing devices. Additionally, by streamlining communications while providing for computer network based ordering and pickup facilitation, the computing system can reduce the amount of communications to and from mobile user devices, thereby reducing bandwidth usage of one or more communications networks and freeing up communications bandwidth for other purposes. Additionally, unique user interface elements at the user devices can improve user experience thereby leading to improved outcomes with respect to efficiency and accuracy of both user interactions with the user devices and fulfillment of orders.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is diagram of an example system for facilitating drive-up order fulfillment.

FIG. 2A-Y show example user interface displays for computing devices in a drive-up order fulfillment system.

FIG. 3 is a flowchart of a process to be performed by one or more computing devices in a drive-up fulfillment system when a user prepares an order for a drive-up customer.

FIG. 4 is a flowchart of a process to be performed by one or more computing devices in a drive-up fulfillment system when a user delivers an order to a drive-up customer.

FIG. 5 is a flowchart of a process to be performed by one or more computing devices in a drive-up fulfillment system when a user stops preparing an order for a drive-up customer.

FIG. 6 is a flowchart of a process to be performed by one or more computing devices in a drive-up fulfillment system when a user cancels an order for a drive-up customer.

FIG. 7 is a flowchart of a process to be performed by one or more computing devices in a drive-up fulfillment system when a user cancels an item in an order for a drive-up customer.

FIG. 8 is a flowchart of a process to be performed by one or more computing devices in a drive-up fulfillment system when a drive-up customer cancels an item in an order.

FIG. 9 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, and techniques for coordinating users, such as employees, in fulfilling drive-up and/or pick up orders in fulfillment locations (e.g., retail environments such as physical stores, warehouses, storage facilities, etc.). Each user can view a list of orders to be fulfilled in GUIs presented at their user devices. The users can select options to view a list of all orders, orders for customers who are on their way to the fulfillment location, and orders for customers who have arrived at the fulfillment location. The orders can be ranked based on priority, such as estimated time of arrival or time since arrival at the fulfillment location. Icons can be presented in the GUIs to indicate stages of preparation for the listed orders. For example, the icon can include an indication such as “Not yet started,” “In hold,” and “Guest ready.” Each of these indications can represent a different stage of order preparation. For example, “Not yet started” can indicate orders that have been received but not yet put together into bags by an employee at the fulfillment location. “In hold” can indicate orders that have been put together into bags and left in one or more hold locations before a customer arrives and/or while the customer is on their way to the fulfillment location. “Guest ready” can indicate orders that have been moved from the one or more hold locations to another location to go out to customers (e.g., when the customer is a predetermined amount of time away from the fulfillment location and/or when the customer indicates that they have arrived at the fulfillment location). Each icon can also indicate how many orders are at each respective stage. By selecting one of the icons, a user can view a list of orders categorized and/or prioritized based on priority in the respective stage. The user can further select an order displayed in any of the lists described herein to view information about that order.

The user can take ownership of an order by selecting a control, such as a button, to “prep” or prepare the order. Selecting this control causes the GUIs on the other user devices to update with an indication that the order is now being preparing by a user. For example, an identifier for the user (e.g., their name) can be displayed next to the order in the GUI of each of the other user devices. When the user selects the control, another GUI can be presented at their user device for the order, which can show a number of bags and a number of items per bag to be scanned out of hold location(s). The GUI may also show information about the hold location for each bag since some bags in the same order can have different hold locations (e.g., a bag of dairy goods can be stored in a refrigerated location while a bag of dog treats can be stored in a non-refrigerated location). The user can select a displayed bag to view a list of items for the bag and to verify that those items are present in the bag. When the user scans the bags out of the hold locations, indications for the bags can be updated in the GUI to show that the bags have been scanned. For example, indications for the bags can be updated from a black or grey color to a green color once the bags are scanned. Once all the bags are scanned for the order, a selectable option can be presented in the GUI for the user to complete preparation of the order. Selecting this option can cause the order to be moved to a list of orders in the “Guest ready” tab presented in the GUI at all the user devices. The same user or a different user can then select a control (e.g., button) to take ownership of delivering that prepared order to the customer.

While an order is being prepared, the user can select an option to cancel preparation, which can cause the GUI presented at the user devices to update and show that the order is no longer being prepared by the user (and thus can be claimed by another user). Similarly, the user can cancel an item in an order using the disclosed techniques. The customer may also cancel an item from an order already in a hold location using their own computing device (such as a smart phone). The customer's computing device can transmit a communication to the user's device (e.g., through one or more servers) indicating that the item has been cancelled from the order. When the user scans a bag for the order during the preparation stage, they can be presented with a notification at their user device indicating that the cancelled item should be removed from the bag before the bag is scanned. Moreover, an indicator such as a hazard symbol can be presented over the indication of the bag that has the cancelled item, thereby alerting the user of a potential issue with the bag.

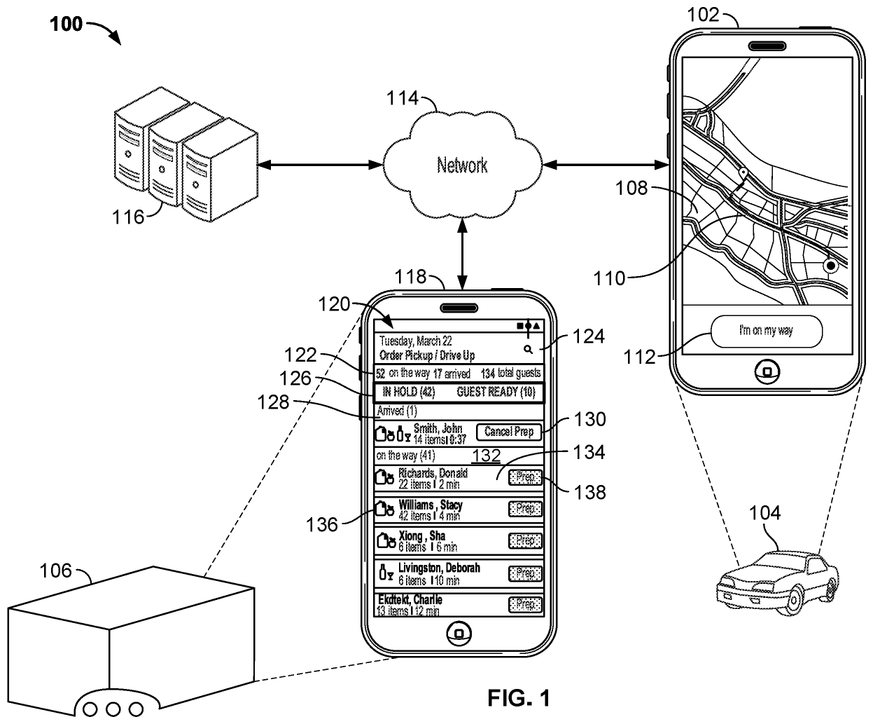

Referring to the figures, FIG. 1 is a diagram of an example system 100 for facilitating order fulfillment for drive-up pickup by customers. In the system 100, a customer who wishes to complete an online order for items by picking up the items using a drive-up service can access a dedicated application executing on a mobile device 102. The mobile device 102 can be, for example, a mobile phone, a tablet device, a touch screen computer, a laptop computer, a PDA, a smart watch, or other mobile device. In some implementations, instead of accessing a dedicated application executing on the mobile device 102, the customer can use a browser of the mobile device 102 to access a website that provides the below described functionality. Therefore descriptions related to use of the dedicated application apply equally to a web-based implementation.

The customer can use the dedicated application to select items for purchase from a store or other fulfillment location using an online shopping interface. For example, the dedicated application can be a grocery shopping application that can permit the customer to search and/or browse for grocery items, add desired items to a virtual shopping cart, and place an order for the selected items by entering payment information. The customer can also use the dedicated application to access one or more previously entered orders. For example, a user may have previously logged into an online account for a retailer associated with the dedicated application and placed an on-line order for one or more items using either the mobile device 102 or a different computing device such as a home or laptop computer. As another example, the customer may have previously placed an on-line order using the dedicated application. The customer can access and review the previously placed orders after logging into the dedicated application. This can include reviewing items included in the orders, estimated time until the order is ready, payment used for the order (e.g., “card ending in 123”), a fulfillment location for the order, and other information associated with the orders.

The mobile device 102 can communicate with other computing devices through a network 114, such as, for example, the Internet. For example, the mobile device 102 can communicate with a network access point such as a WiFi router or a cellular communication tower to access the network 114 and communicate with other computing devices. For example, the mobile device 102 can communicate with a server system 116 consisting of one or more servers to place the order. Alternatively, or additionally, the customer can use a different computer to place the order and the different computer can communicate through the network 114 with the server system 116. The server system 116 can be affiliated with a retailer and process the on-line order received from the mobile device 102 or another computing device. The server system 116 can facilitate fulfillment of the order by providing details of the order, such as ordered items, identity of the customer, an order number, time that the order was placed, etc. to one or more computing devices located at a fulfillment center such as a store 106. For example, the store 106 can be part of a chain of affiliated stores associated with a retailer and the server system 116 can be a server system associated with the retailer. Upon receiving an on-line order from the customer, the server system 116 can identify the store 106 as an appropriate fulfillment location for the order based on information such as, an indication of a preferred location for fulfillment indicated by the customer at the mobile device 102 or another computing device, a current location of the mobile device 102, another location associated with the customer (e.g., home or work address information entered by the user into a customer profile), based on item availability (e.g., by identifying a store where all or a majority of the items in the order are in stock), or based on a combination of these and one or more other factors.

For example, the server system 116 can identify the store 106 as an appropriate location for fulfilling the customer's order. The server system 116 can transmit information on the order to a computing device 118 in the possession of, or being used by, a user such as an employee of the store 106. The computing device 118 can be a mobile computing device, such as, for example, a mobile phone, a tablet device, a touch screen computer, a laptop computer, a PDA, a smart watch, or other mobile device. In some implementations, the computing device 118 can be a non-mobile or semi-mobile device such as a server, a desktop computer, a cash register, a smart TV, or other computing device. The server system 116 can provide appropriate information for the order to the computing device 118 such as items in the order, identifying information for the customer who placed the order, time the order was placed, a desired pickup time for the order (e.g., as indicated by the customer at the time of placing the order), an order number, and other relevant information.

At the time of placing the order, or at a different time, such as when logging into the dedicated application, the customer of the mobile device 102 can indicate a desired order fulfillment method for the order. For example, the customer can specify that the order is for drive-up fulfillment. A drive-up fulfillment allows the customer to drive to a fulfillment location, such as a retail store location, a warehouse, or another location where an employee of the retailer can meet the customer at the customer's vehicle 104, verify that the customer is receiving the proper order, and provide the items to the customer without the customer being required to exit their vehicle. For example, the customer can travel to the store 106, park in a designated area of the parking lot of the store 106, notify an employee that they have arrived using the dedicated application, and then receive the purchased items from the employee when the employee brings the items to the customer's vehicle 104.

As another example, the customer can specify that the order is for in-store pickup fulfillment. In-store pickup fulfillment can allow the customer to travel to a fulfillment location, such as the store 106, and enter the store to pick up the purchased items from a designated location within the fulfillment location. Such a fulfillment method can allow the customer greater flexibility by allowing the customer to shop for additional items within the store 106 (e.g., items that the customer wishes to see in-person before purchasing, such as clothing or produce) and then pick up the items from the on-line order at the designated location after completing their in-store shopping. Alternatively, the customer can pick up the order items without also shopping for items at the store 106 in person.

As another example, the customer can specify that the order is for delivery. An employee of the retailer or a third-party service can travel to the customer's home or another drop-off location designated by the customer to deliver the items in the order to the customer.

In the case of both drive-up and in-store pickup type order fulfillments, the customer can begin to travel to the fulfillment location, such as by driving the vehicle 104 to the store 106. In some implementations, information collected or generated by the mobile device 102 can be used to determine that the customer has begun to travel to the order fulfillment location. For example, location information determined by the mobile device 102, as described above, can be used to determine that the mobile device 102 has begun to travel along the route 110. For example, the dedicated application can receive location information for the mobile device 102 over sequential periods of time (e.g., every 2 seconds) and compare the movement of the mobile device 102 based on the changing location information to the route 110 to determine that the customer has begun to travel the route 110. Alternatively or additionally, the customer can select a user interface control 112 provided by the dedicated application to indicate that they have begun traveling toward the store 106. For example, the customer may have selected a permissions setting to not allow the dedicated application to access location information for the mobile device 102. In some implementations, the dedicated application will only display the user interface control 112 in situations in which the customer has not permitted the dedicated application to access location information for the mobile device 102. As another example, the mobile device 102 may be unable to accurately determine its location, for example, due to tall buildings interfering with GPS signals or due to lack of wireless communications access points in the area around the mobile device 102. The dedicated application can provide the user interface control 112 when the mobile device 102 is unable to accurately determine the location of the mobile device 102 so that the customer can indicate that they have begun to travel toward the store 106.

Upon determining that the customer has begun to travel toward the store 106 (e.g., based on location information collected by the mobile device 102 or based on user interaction with the user interface control 112), the mobile device 102 can communicate with one or more computing devices located at and affiliated with the store 106, either directly through the network 114 or by communicating with the server system 116 which in turn communicates appropriate information and instructions to the one or more computing devices located at the store 106. For example, an employee of the store 106 can use the computing device 118, which can receive information relevant to the order from the server system 116. The mobile device 102 can communicate with the server system 116 over the network 114 to indicate to the server system 116 that the customer has begun to travel toward the store 106. The server system 116 can then provide a communication to the computing device 118 of the employee to update information presented at the computing device 118 indicating that the customer of the mobile device 102 is on the way (and thus, that the order for the customer should be prepared and ready for the customer's arrival). The server system 118 may communicate directly with the computing device 118 through the network 114 or may communicate with a computing device/system located at the store 106 which then communicates with the computing device 118, e.g., through a wireless or wired local area network (LAN). In some implementations, the server system 116 or a central computing device located at the store 106 can communicate with the computing device 118 and one or more other computing devices in possession of other employees of the store 106 to allow multiple employees to receive information on on-line orders placed by customers and coordinate efforts to fulfill such orders.

The server system 116 can provide additional information along with this notification or prior to sending the notification that the user is on the way. For example, the server system 116 can provide vehicle identification information to the computing device 118 to allow the employee to more easily identify the customer's vehicle 104 when the customer has arrived at the designating drive-up fulfillment location at the store 106. The server system 116 can also provide information on an estimated time of arrival and/or an estimated time until arrival for the customer. Such timing information can be used to determine ranking of orders to be prepared in a GUI presented at the computing device 118. Therefore, the employee can use the timing information to prioritize which orders to prepare.

The computing device 118 includes a user interface 120 (e.g., GUI). The user interface 120 can, for example, be a user interface for another dedicated application executing on the computing device 118 or another instance of the same dedicated application that is executing on the mobile device 102. The user interface 120 includes a panel 122 having icons for different stages of order fulfillment. The icons can represent “On the way” stage, an “Arrived” stage, and a “Total guests” stage. Each icon can also include a numeric indication of how many orders are at the respective stage. The employee can select any of the icons to view, in the user interface 120, orders at the respective stage. The employee can select the control 122 by, for example, using a touch screen interface of the computing device 118 or one or more other input devices of or in communication with the computing device 118. The panel 122 can be a pickup dashboard, which can provide a quick and easy to understand overview of what is happening with pickup activities at the store 106. The panel 122 can indicate how many customers have notified the store 106 that they are on their way, how many customers have confirmed that they are at the store 106, and a total number of customers who have at least one order in a hold location. Thus, the panel 122 can indicate total customer counts rather than total order counts. A customer, for example, may have multiple orders but may only be counted once in the panel 122.

The user interface 120 further includes a control 124 to allow the employee to search for orders. The employee can type, using one or more input devices of the computing device 118 and/or by tapping on a touchscreen of the computing device 118 to select keys on a keyboard presented in the user interface 120, order numbers, customer names, or other identifying information into the control 124. Results from the employee's search can populate the user interface 120 or be presented in another user interface at the computing device 118. In some implementations, a customer may not have their barcode available when they arrive for pickup. So, the customer can search by the customer's name, order number, or other information using the control 124. If, on the other hand, the customer has their barcode or other identifier on hand, the employee can scan the barcode from the user interface 120 to process their order for pick up.

The user interface 120 also includes a panel 126 with selectable options for tabs: “In hold” and “Guest ready.” The selectable options may also include a numeric indication of how many orders are associated with each tab. The employee can select either of these options to view, in the user interface 120, lists of orders associated with “In hold” or “Guest ready.” Orders may be classified and listed under “In hold” if they have not yet been prepared and/or are currently being prepared. Orders may be classified and listed under “Guest ready” if employees completed preparation of such orders and the orders are ready to be delivered to customers upon their arrival at the store 106. Moreover, all orders for customers who indicated they are on their way can fall under the “In hold” or “Guest ready” tabs. In some implementations, both the “In hold” and “Guest ready” tabs can present lists of customers who have arrived and customers who are on their way. This presentation of information can be beneficial to help the employees prioritize which orders to prepare.

In the example depicted in FIG. 1, the dedicated application for employees can default to presenting “In hold” information in the user interface 120. The employee can also select the option for “In hold” in the panel 126. As a result, a list of orders that are not yet ready to be delivered to customers are presented in the user interface 120. The orders are depicted in an “Arrived” panel 128 and an “On the way” panel 132 to help the employee prioritize preparation of the orders that are “In hold.”

As described throughout this disclosure, there can be three stages of order preparation. Orders that have come in but have not yet been prepared can be in a first stage of order preparation. Once a customer indicates that they are on their way, an employee can start to prepare the customer's order. Once the order is put together, the employee can leave bags associated with that order in one or more hold locations. At this point, the order can be given a status of “In hold” (and thus, the order can appear in either of the panels 128 and/or 132). Either when an estimated time of arrival for the customer hits a certain threshold (e.g., 5 minutes) or the customer has indicated that they have arrived, an employee can move the bags associated with the customer's order from the hold locations to a second holding location, which is for orders that are ready to go out to customers' vehicles. At this point, the status of the order can change from “In hold” to “Guest Ready.”

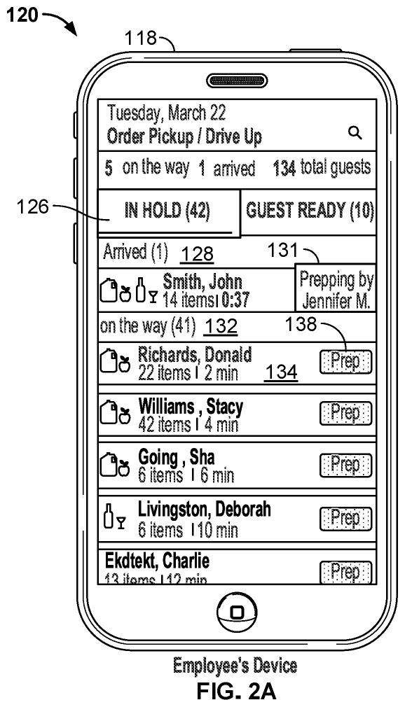

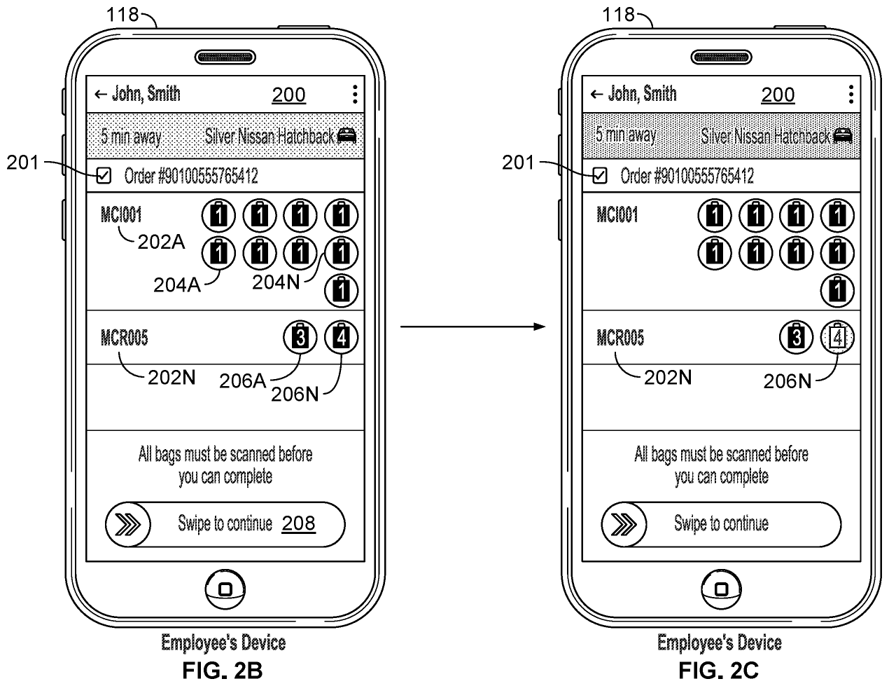

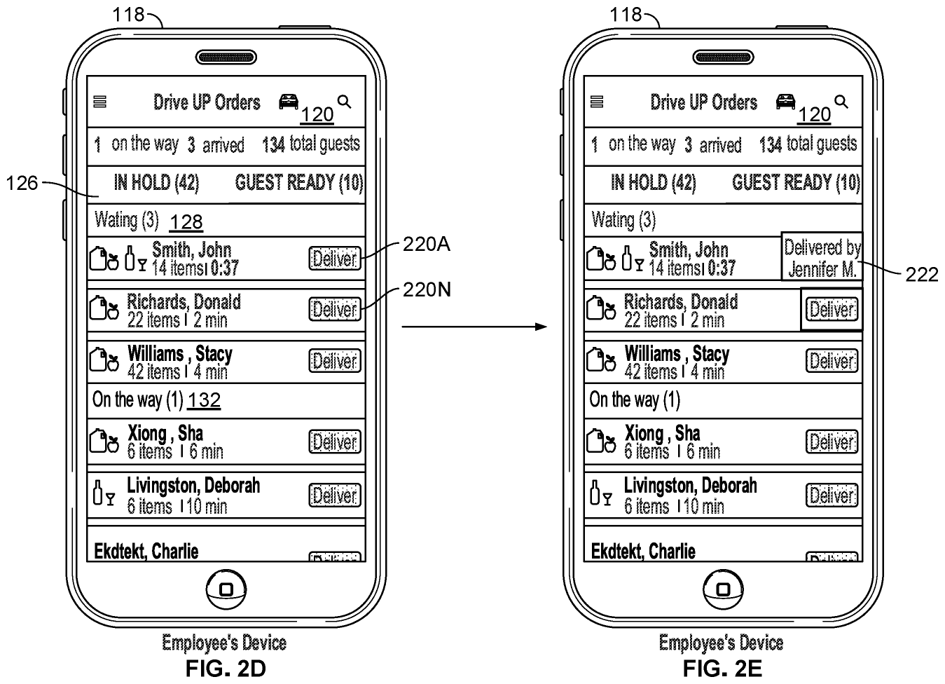

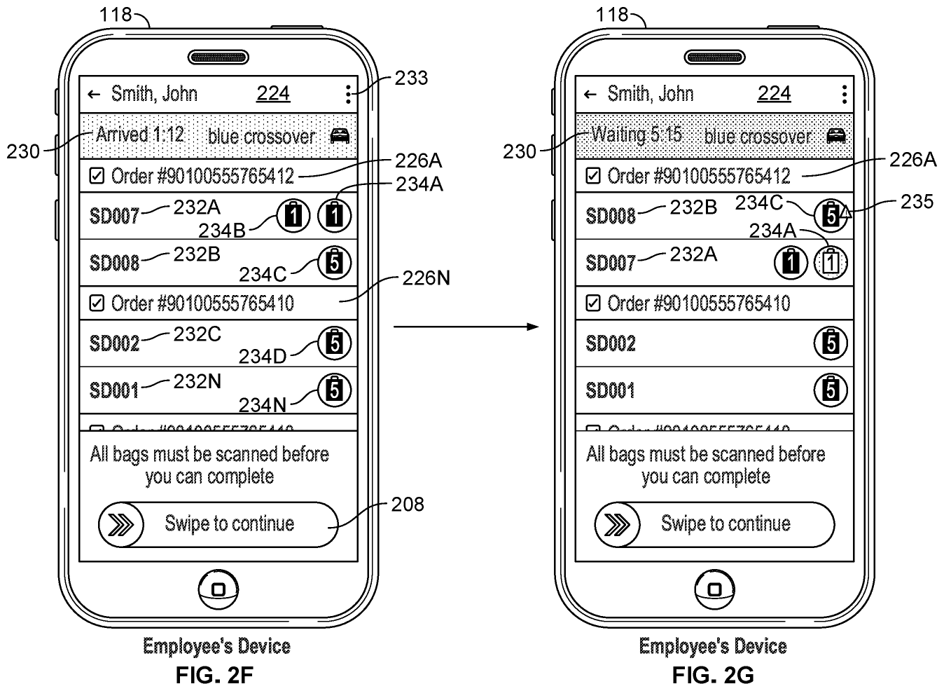

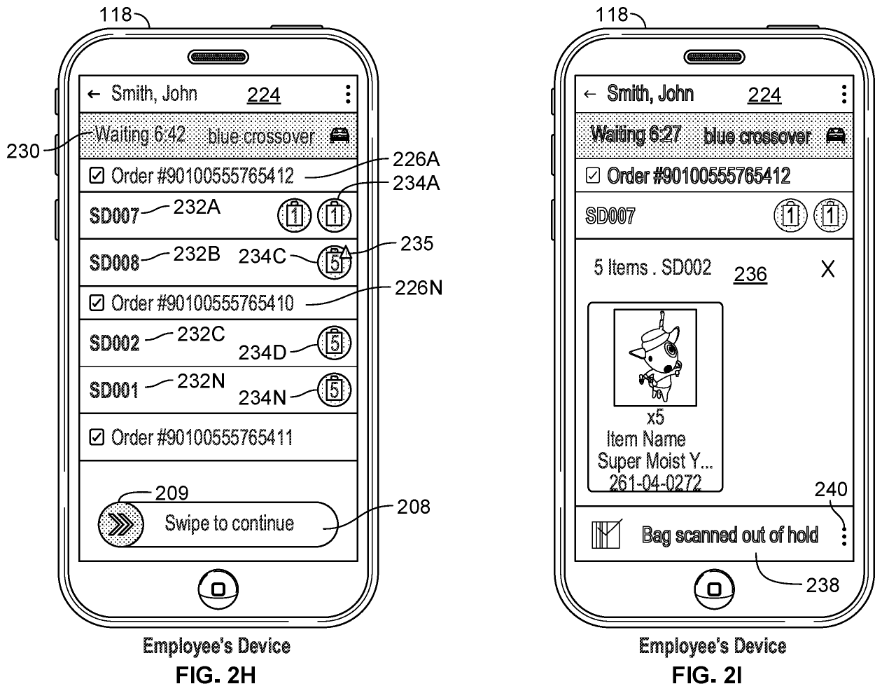

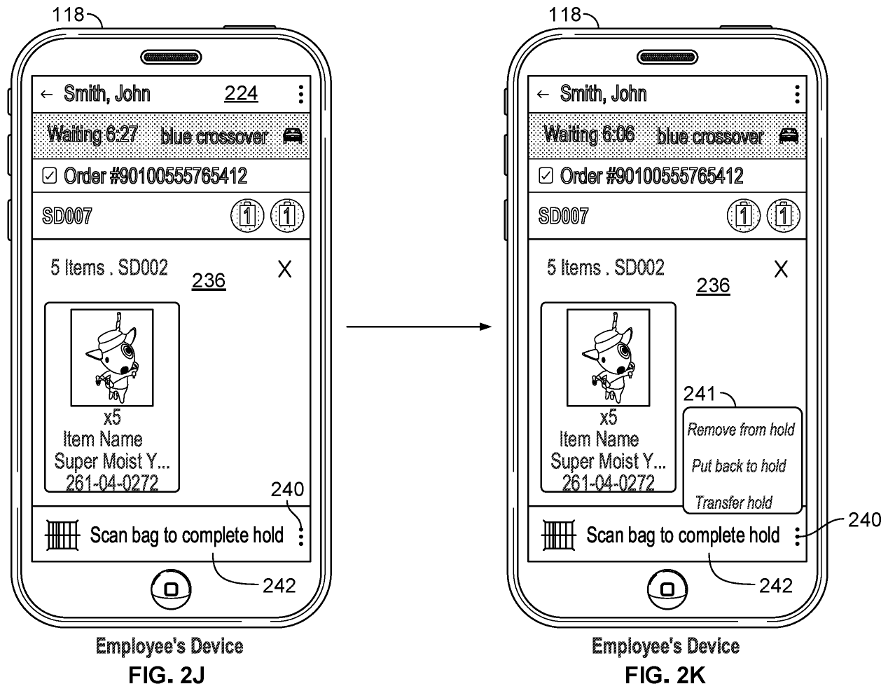

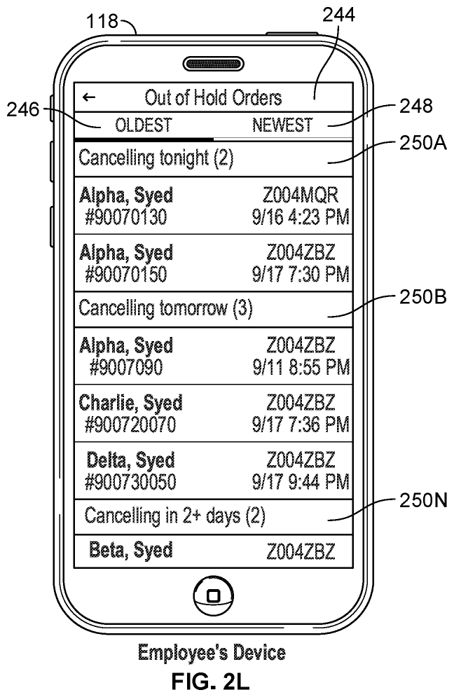

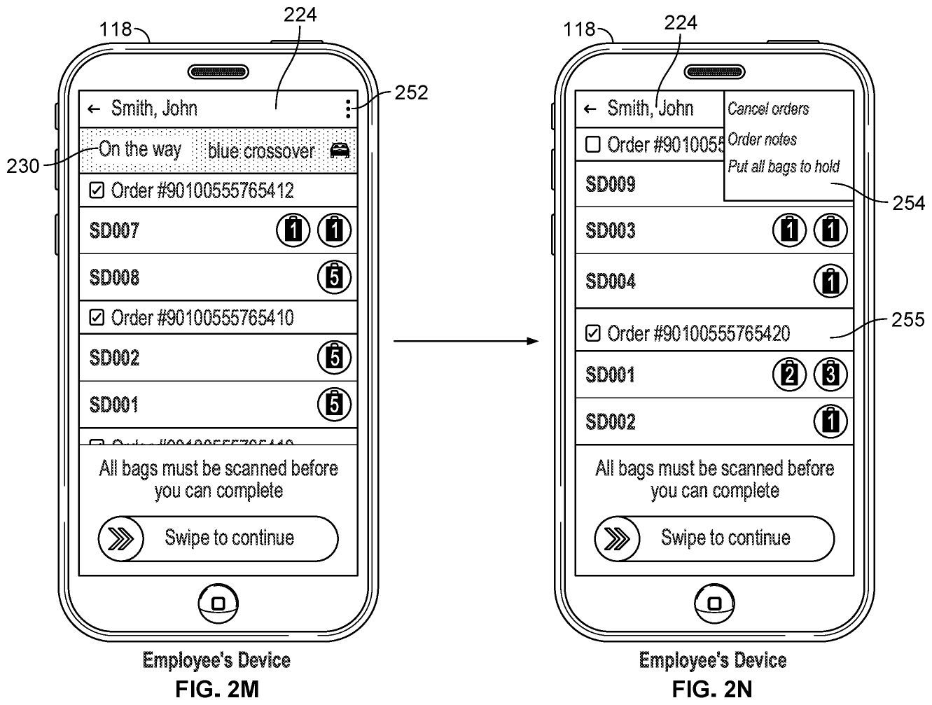

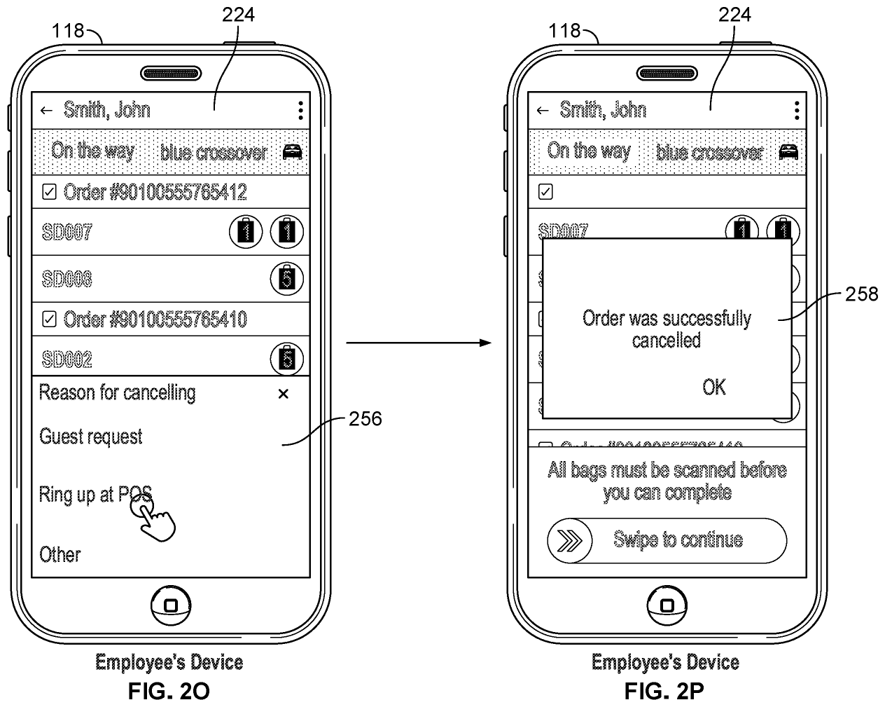

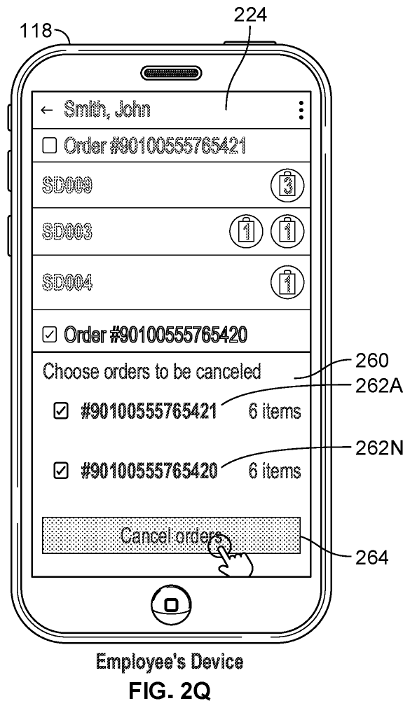

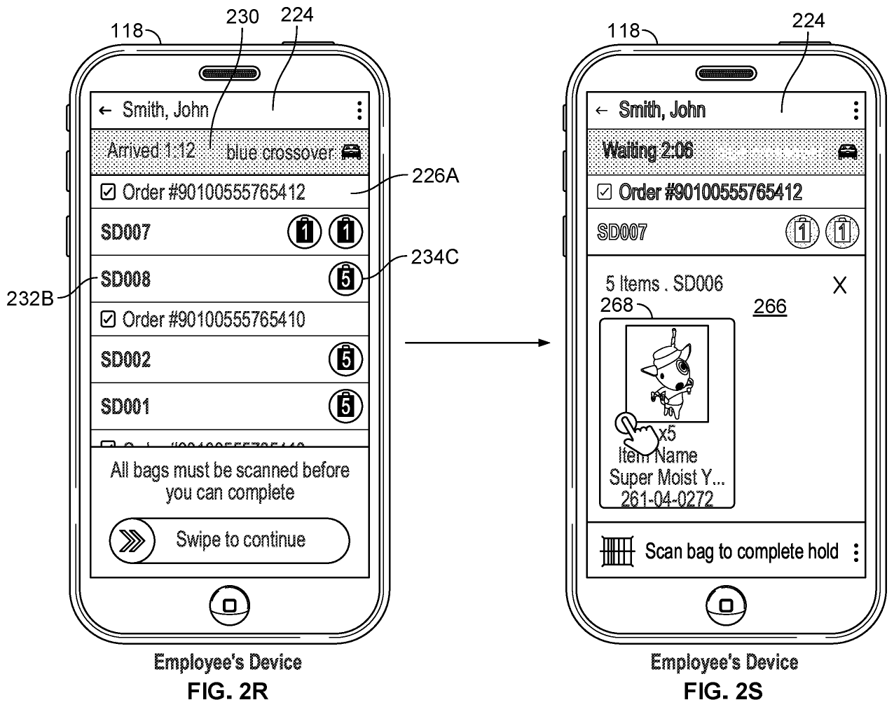

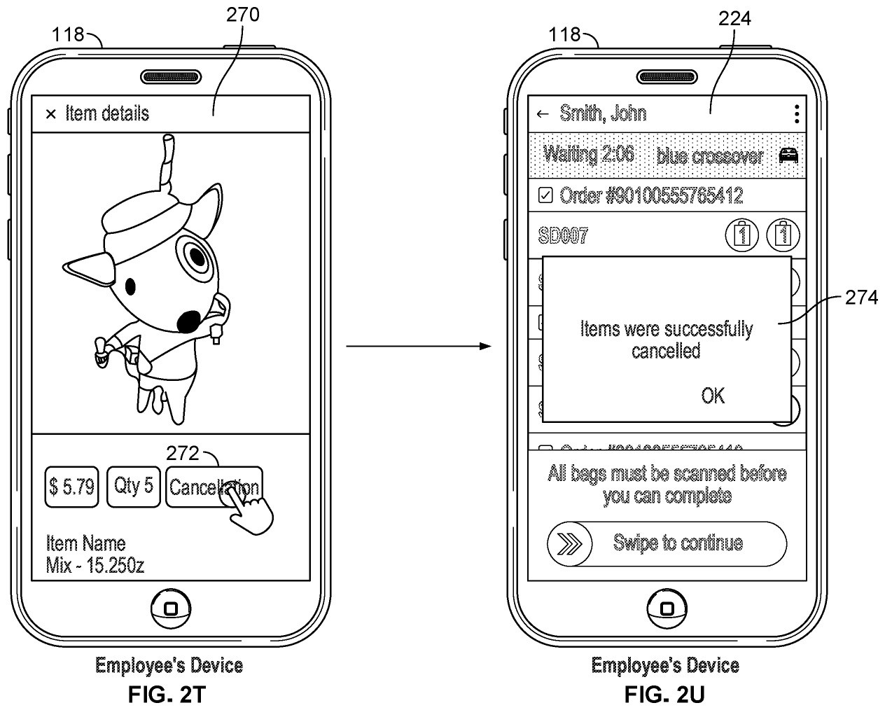

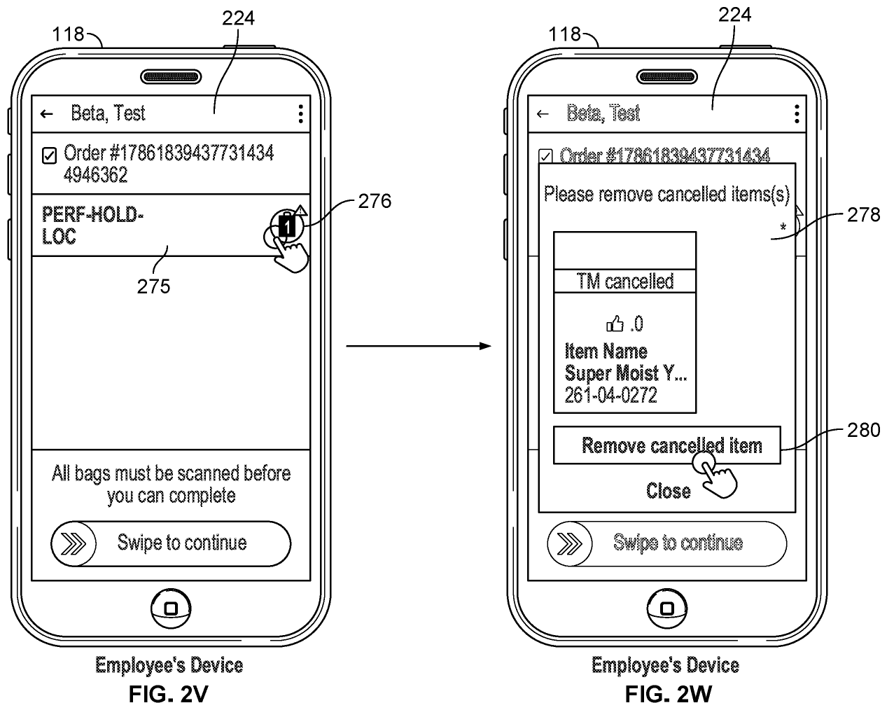

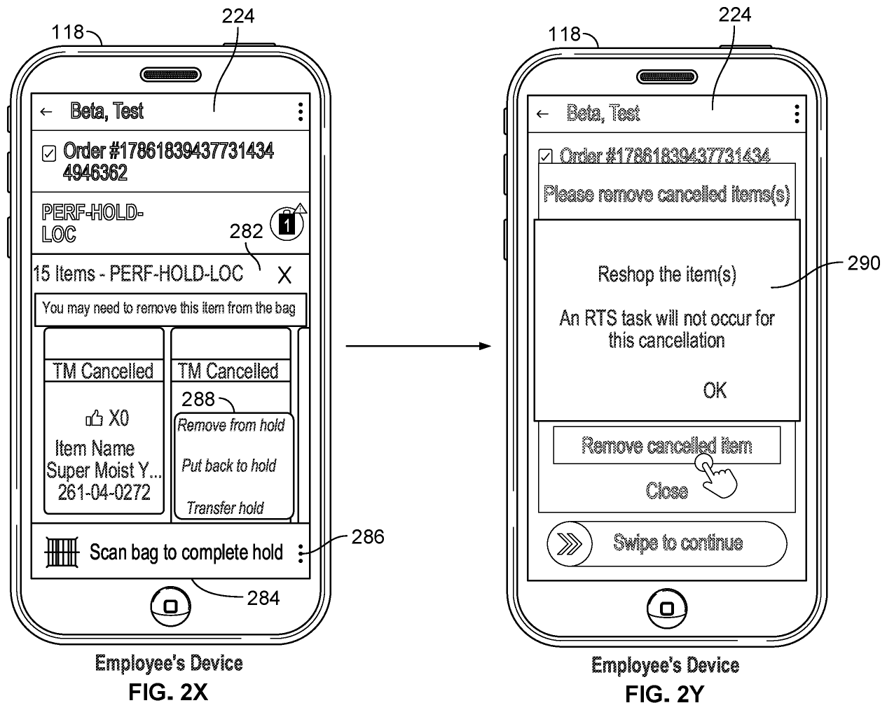

Controls can be presented in the panels 128 and 132 with each order. For example, an order in the panel 128 includes a control 130, which indicates “Cancel prep.” The employee can select the control 130 in order to cancel preparation of this order. In some implementations, the employee may cancel preparing the order at any time. Thus, the employee can cancel preparation (or delivery) of an order when they do not anticipate returning to the order (e.g., when the employee goes on a break, leaves for the day, etc.). Once the employee selects the control 130 and confirms that they are canceling preparing of the order, the control 130 can change to control 138 in each computing device 118 of employees in the store 106. Any employee can then claim a task of preparing the order. Any preparation scans that were made during a prior preparation process may not be recorded and whoever claims the task of preparing the order must scan every bag for the order. In some implementations, an employee can cancel another employee's claim of preparing an order in scenarios in which the another employee is no longer available (e.g., on break, left the building, etc.). To do so, the employee can click, tap, or otherwise select an order from the panel 128 or the panel 132, which can present another user interface at the computing device 118 (e.g., refer to FIG. 2B). In the another user interface, the employee can click, tap, or otherwise select a menu option (e.g., a three-dot menu located at the top right corner of the user interface 200 in FIG. 2B) and then an option within the menu to “cancel work.” By selecting this option, the user interface 120 can be updated as described above in reference to cancelling an order as it is currently being prepared.

Orders in the panel 132 also include control 138, which indicates “Prep.” The employee can select the control 138 next to any of the orders in the panel 132 in order to begin preparing that order while the customer is on the way. The employee can therefore claim the task of preparing an order by selecting the control 138 for that order. The employee can also claim the task of preparing more than one order by selecting the control 138 for each order the employee desires to prepare. Moreover, graphical elements 136 are presented with each order in the panels 128 and 132. The graphical elements 136 can indicate one or more types of items that are part of the respective order (e.g., grocery items, alcoholic beverages, etc.).

Each panel 128 and 132 can include order listings, such as order listing 134. Order listings in the panel 132 can be organized alphabetically by customer name since not every customer may share their location information. Order listings in the panel 128, on the other hand, can be organized by first in first out logic to help prioritize which orders should be worked on and completed first.

The order listing 134 is in the “On the way” panel 132. The order listing 134 has not yet been claimed by an employee to be prepared. Therefore, the order listing 134 is displayed with the control 138 to “Prep” the order. The order listing 134 includes customer information. A customer name listed in the order listing 134 can match a label placed on one or more bags for the respective order. The order listing 134 can also include an item count, indicating how many items are in the order. In some implementations, the order listing 134 may include a bag count. The order listing 134 can also include a number of minutes as an ETA based on information shared from the customer's device 102 as the customer is on their way to the store 106. Depending on the customer's application settings, the ETA may not be updated in real time. In some implementations, for example, no ETA may be shown in the order listing 134, which can indicate that the customer has chosen not to share their location information. When the customer arrives at the store 106, their order listing 134 can be moved from the “On the way” panel 132 to the “Arrived” panel 128. The ETA in the order listing 134 can then be changed to a timer indicating how much time has passed since the customer indicated that they arrived at the store 106.

In some implementations, order listings in the panels 128 and 132 are user selectable to allow the employee to view additional information about each order (as explained in greater detail below). Additional details that can be displayed at the computing device 118 in response to selection of an order can include an order number, a list of bags to scan out of hold locations and/or a number of bags for the order, location information for the bags (e.g., one or more shelf or bin locations at a drive-up order fulfillment staging area), a quantity of items per bag, a listing of items in the order, vehicle identification information, special instructions or requests entered by the customer, an indication as to whether or not the order includes age restricted items (e.g., cold medicine, alcohol, etc.), and other information for the order. Refer to FIG. 2A for additional discussion about the user interface 120.

In some implementations, the computing device 118 can receive a notification, from the server system 116, that a customer is on their way to the fulfillment location at the store 106. The notification can include an order identifier that includes an order number for the customer's order and an indicator of the estimated time until the customer arrives at the store 106. In some implementations, the employee can select the notification or a control displayed as part of the notification to cause the computing device 118 to display a page of the order fulfillment application that includes additional details on the order, customer, or related info.

When the customer arrives for drive-up or pickup, a barcode or other identifier can be presented at the mobile device 102, which can be scanned by the employee using the computing device 118 and/or a scanning device to verify the customer's identity and verify that the order was provided to the customer. For example, the employee can retrieve the bags for the customer's order from appropriate storage bins located at or near the in-store pickup fulfillment location and provide the bags containing the order to the customer. The employee can then scan the barcode and the computing device 118 can provide a notification indicating that the scanned barcode matches the customer or their order to ensure that the employee has provided the correct order. Scanning of the barcode can also cause the computing device 118 to display information indicating that the customer has already paid for the order. In some implementations, another scanable code or identifier, such as a QR code, can be displayed, or a human readable numeric or alphanumeric code can be displayed on the customer's mobile device 102.

When the customer arrives to pick up an order, the user interface 120 can update to show that the customer has now arrived and has switched the estimated time of arrival indication for a particular order to a time since arrival timer. In other words, the timer can switch from a count-down timer indicating an estimated time until arrival to a count-up timer indicating the amount of time since the customer arrived. In some implementations, when the timer switches from a count-down, ETA timer to a count-up, time since arrival timer, the user interface 120 can change the appearance of the timer. For example, the timer can be displayed in grey during count-down and then can be displayed in green when the timer switches to a count-up timer. Other appearance changes, such as italics, bold, flashing, change in size, change in location, change in background color for the order, a box or circle around the timer, or other display change can be used to visually indicate to the employee that the customer has arrived and that the order fulfillment should be completed before the customer is waiting too long. If the timer runs for over a predetermined period of time since the customer arrived, the timer may be represented in a red color to warn the employee that the customer has been waiting too long. In some implementations, the count-up timer can be stopped or cleared in response to an event. For example, the employee can use one or more controls of one of the user interface screens of the computing device 118 to indicate that the order has been fulfilled. Completion of the order fulfillment can cause the timer to stop or be cleared.

FIG. 2A-Y show example user interface displays for computing devices in a drive-up order fulfillment system. FIG. 2A depicts the user interface 120 in which the employee at the computing device 118 can claim a task of preparing an order. As shown in the panel 126, the “In hold” tab is selected and presented in the user interface 120. The “In hold” tab shows orders that have either not been started to be removed from hold, or that are in the process of being scanned out of hold. Forty-two orders are currently categorized as “In hold” and thus presented in the panels 128 and 132.

In the panel 128, one customer, “John Smith” has arrived and has been waiting for 37 seconds. An indication 131 is presented with John Smith's order listing in the panel 128 to indicate a stage of preparation for this order. The indication 131 states “Prepping by Jennifer M.” The indication 131 can be presented in the user interface 120 at at least a subset of every computing device 118 of employees at the fulfillment location. Therefore, employees of the subset of computing devices 118 can be notified that the order is currently being prepared and therefore does not need to be claimed by another employee.

Orders that have not yet been completely prepared, can be shown with the control 138. The control 138 can be a red button with the text “Prep.” The control 138 can be presented next to each order listing, such as the order listing 134, in either panel 128 and 132 that has not yet been prepared. It can be preferred for employees to claim orders that appear in the “Arrived” panel 128 with the control 138 since those customers will be arriving sooner and thus likely waiting longer for their orders if those orders are not prepared.

As described above, when an employee claims an order for preparation by selecting the control 134, their name or other identifier can appear as the indication 131 in the user interface 120 presented at the computing devices 118 of the employee's coworkers. The indication 131 can appear in real time and/or near real time across all the computing devices 118 so that the coworkers can become aware that the order has been claimed. If another employee tries to select the control 134 for an order that has already been claimed, an error message can be presented at their respective computing device 118. As a result, no two employees can claim the same order at the same time.

Once the employee selects the control 134 for an order listing, the user interface 120 can be updated with order information as shown in FIGS. 2B-C. FIG. 2B shows an example user interface 200 when the employee selects a control to prepare a particular order (e.g., the control 134 in FIG. 2A). The user interface 200 can be an order preparation screen displayed at the computing device 118. Here, the employee has selected a control to prepare the order for customer “John Smith.” For example, the employee may have selected a control similar to the “prep” control 138 of FIG. 2A or the control 134 of FIG. 2A associated with the order for John Smith to let the system know that the employee will prepare the pending order (or orders) for John Smith. Alternatively, the system can include a control on the user interface 200 that allows the employee to indicate that the employee will prepare the order for John Smith, such as a checkbox 201 shown next to the order number for John Smith's pending order in FIG. 2B. In some implementations, the prep buttons (such as prep control 138 of FIG. 2A) are absent from the user interface 120 and the employee is required to select an order form the user interface 120 to cause the user interface 200 to be displayed and then must select the control 201 to indicate to the system that the employee is responsible for preparing the indicated order (or orders). The user interface 200 indicates information such as when the customer is expected to arrive, vehicle identification information, an order or orders to be fulfilled, a hold location or multiple hold locations for the order, bags and associated with the order, quantities of items in each bag, and a selectable option 208 to complete preparation of the order. As shown, the option 208 may be grayed out and therefore not selectable until the preparation process has been completed for John Smith's order.

More particularly, the user interface 200 can include hold location indications 202A-N. The indications 202A-N can indicate identifying information for locations in the fulfilment location where bags for John Smith's order are held. As shown in FIG. 2B, bags for a same order can be spread out and stored in multiple different hold locations. Some hold locations may be refrigerated and thus used to store bags of items that need to remain cool/refrigerated/frozen before pickup. Some hold locations may be non-refrigerated and designated for bags containing grocery items that do not need to be refrigerated. Moreover, some hold locations may be non-refrigerated and designated for bags containing non-grocery items, such as electronics and clothes. One or more other types of hold locations are also possible.

The user interface 200 also includes indications 204A-N and 206A-N for bags that make up John Smith's order. Each of the indications 204A-N and 206A-N can be represented in a first indicia until the respective bags are scanned by the employee during the preparation process. The first indicia can be a color, such as black. Once the employee scans a bag, using their computing device 118 and/or a scanning device in the fulfillment location, the corresponding indication 204A-N and/or 206A-N can be updated in the user interface 200 to a second indicia. The second indicia can be another color, such as green. Once all the bags have been scanned and thus all the indications 204A-N and 206A-N are represented in the second indicia (e.g., green), the option 208 can become selectable (and thus no longer grayed out) so that the employee can complete the preparation process for the order presented in the user interface 200.

Here, the indications 204A-N represent bags for John Smith's order that are located in a hold location represented by the indication 202A and the indications 206A-N represent bags for John Smith's order that are located in a hold location represented by the indication 202N. The indications 204A-N and 206A-N are graphical depictions of bags. Each of the indications 204A-N and 206A-N also includes a numeric value indicating how many items are in each respective bag. In the example of FIG. 2B, there are 9 indications 204A-N for 9 bags located in the hold location 202A and 2 indications 206A-N for 2 bags located in the hold location 202N. Each of the 9 bags in the hold location 202A have 1 item while one bag (as shown by the indication 206A) in the hold location 202N has 3 items and another bag (as shown by the indication 206N) in the hold location 202N has 4 items.

FIG. 2C shows the bag indication 206N represented in the second indicia, such as a green color or other pattern. This means that the employee has scanned the bag represented by the indication 206N in the hold location represented by the indication 202N. As the employee scans each remaining bag for John Smith's order, the respective indications 204A-N and 206A-N in the user interface 200 may be updated to the second indicia as well.

Referring to both FIGS. 2B-C, the employee may prepare and deliver John Smith's order. In that scenario, the employee may scan all the bags represented by the indications 204A-N and 206A-N once, during the preparation process. If, however, a different employee delivers John Smith's order, then the employee may scan the bags out of the hold locations and the different employee may also scan the bags to verify they are accurate after selecting an option to deliver the order to John Smith. During the preparation process, the employee may go to each hold location in the fulfillment location represented by the indications 202A-N and scan each of the bags for the order represented by the indications 204A-N and 206A-N. Once all the bag indications 204A-N and 206A-N are represented in the second indicia, the employee can swipe the option 208 across the bottom of the user interface 200. As described throughout this disclosure, swiping the option 208 can cause John Smith's order to be moved to the “Guest ready” tab. Once moved to the “Guest ready” tab, the order may no longer be assigned to the employee who prepared it during the preparation process.

In some implementations, the employee may make order adjustments in the user interface 200. The employee can make price adjustments by clicking or selecting one of the indications 204A-N or 206A-N. As described herein, selecting one of the indications 204A-N or 206A-N can cause information about items in the respective bag to be presented in the user interface 200. The employee can select an item presented in the user interface and an option to change a price of the selected item as well as a reason for changing the price. Selectable reasons for changing the price can include, but are not limited to, “Match store price,” “Item is damaged,” “Other,” etc. The employee can then input a new price and/or a percent to be taken off the price of the item. The price can be updated in the information presented about the selected item. The employee can then select the updated price to apply that price to the particular order. The price can then be presented in the user interface 200 with a green box, highlighting, or other indicia to indicate the price change and that the price change has been accepted and applied.

In some implementations, the employee can also make quantity adjustments by clicking one of the indications 204A-N or 206A-N. Similar to price adjustments, with quantity adjustments, the employee can select a reason for the quantity adjustment and input a value indicating the new quantity for a particular item in the respective bag.

FIG. 2D depicts information presented in the user interface 120 when the employee has selected “Guest ready” from the panel 126. As described above, orders that are prepared can be added to the “Guest ready” tab, as shown in FIG. 2D. Here, the panels 128 and 132 are updated to indicate which of the prepared orders are ready to be delivered to customers who are waiting and customers who are still on their way. In the example of FIG. 2D, three customers are waiting for their orders at the fulfillment location. The customer's orders are listed in the panel 128 from order of first to arrive. Each order can include information indicating how long the customer associated with the order is waiting. The employee can select a control 220A-N next to any of the orders listed in the panels 128 and 132 to claim a task of delivering the respective order to the customer. The controls 220A-N can be buttons with an indication of “Deliver.” The controls 220A-N can be similar to the controls 134 previously described.

FIG. 2E depicts information presented in the user interface 120 when the employee selects the control 220A to deliver John Smith's order (refer to FIG. 2D). As shown, the control 220A can be replaced with an indication 222 indicating that the task of delivering John Smith's order has been claimed. Identifying information of the employee, such as their name or an employee ID, can be presented in the indication 222. The indication 222 can be presented in the user interface 120 of each computing device 118 of the employees in the fulfillment location. As a result, the other employees in the fulfillment location can be made aware in real or near real time that John Smith's order has been claimed by the employee.

Referring to both FIGS. 2D-E, if a customer has arrived, their order appears in the panel 128 and their orders should be prioritized over orders for customers whose orders appear in the panel 132. However, employees may still stage an order in the panel 132 in preparation for the customer's arrival such that the customer does not have to wait an extended period of time when they arrive at the fulfillment location.

The indication 222, as mentioned above, can indicate that an employee claimed the task of delivering the order to the respective customer. Additional or other employees may not work on this order unless the employee backs out and cancels their claim. The employee can cancel their claim to deliver the order similarly to canceling their claim to prepare the order described previously. If the employee cancels the task to deliver the order, the indication 222 can be replaced with the respective control 220A-N in the user interface 120 presented at each computing device 118 of the employees in the fulfillment location. As a result, any other employee in the fulfillment location can now claim the task of delivering that order. Moreover, as mentioned previously, if an employee claims the task of delivering an order but did not prepare that order during the preparation process, then the employee may have to scan all the bags and/or items associated with the other prior to delivery to ensure that the bags are accurate and that no bags and/or items are missing for the order.

Once the user selects a control 220A-N, the user interface 200 discussed in FIGS. 2B-C can be presented at the computing device 118. If the employee delivering the order also prepared the order, the employee's prior scans can be retained and another user interface can be presented at the computing device 118 including a 4-digit code or other identifier used for confirming the customer associated with the order. After all, all the indications 204A-N and 206A-N of the bags may be represented in the second indicia, indicating that all of the bags have been scanned out of the hold locations for the particular order. If the employee delivering the order did not scan the bags during preparing, then a second set of scans may be required. Thus, the employee may scan every bag for the order, as described in reference to FIGS. 2B-C until all the indications 204A-N and 206A-N are represented in the second indicia. The employee can then swipe or select the option 208, which can present the another user interface at the computing device 118 including the 4-digit code or other identifier used for confirming the customer associated with the order. The employee can then enter (e.g., type in) the 4-digit code into an input field in the another user interface to confirm delivery. Once the delivery is confirmed, the respective order may be removed from the “Guest ready” tab described in FIGS. 2D-E and thus updated across all the computing devices 118 of the employees in the fulfillment location.

FIG. 2F depicts a user interface 224 at the computing device 118 for order preparation. The user interface 224 is similar to the user interface 200 described in FIGS. 2B-C. In this example, the employee selected the control 220A in FIG. 2D to deliver the order for John Smith, who has arrived at the fulfillment location. By selecting the control 220A, the user interface 224 can be presented at the employee's computing device 118 while the control 220A is updated to the indication 222 (refer to FIG. 2E) across the other computing devices 118 of the other employees.

From the user interface 224, the employee can scan bags for John Smith's order (or orders) out of hold locations, as described above in FIGS. 2B-C. As mentioned previously, sometimes the employee delivering the order to a customer may not be the same employee who prepared the order. Thus, the employee delivering the order would have to scan the bags out of the hold locations as part of the delivery process. Accordingly, the steps of scanning the bags out of the hold locations described in reference to FIGS. 2F-G can be performed during a preparation stage of an order as well as during a delivery stage of the order.

The user interface 224 includes a field 230 that indicates that the customer John Smith has arrived. The field 230 includes a timer indicating the amount of time that has elapsed since the customer has arrived. In some implementations, prior to arrival of the customer, the field 230 may include an indicator of “order placed” or “on the way” to indicate the customer's status (e.g., refer to FIGS. 2B-C). For example, the field 230 can indicate that the customer is on the way and the timer can indicate an ETA for the customer. The field 230 further includes vehicle identification information for the customer to allow the employee to more easily identify the customer's vehicle when bringing the customer's order items to the drive-up fulfillment location in the parking lot of the fulfillment location. The field 230 further may include an icon, such as a car, indicating that the order(s) for the customer are drive-up fulfillment orders (rather than in-store pickup, delivery, etc.).

Additionally, the field 230 can be represented in different indicia, such as colors (e.g., patterns, boxes, highlighting, etc.), based on how long the customer is waiting. For example, if the customer has just arrived and is waiting for less than a threshold period of time, according to the timer, the field 230 can be represented in a first indicia, such as a green color. If the customer now waits for more than the threshold period of time, according to the timer, the field 230 can be updated and represented in a second indicia, such as a red color. Furthermore, as shown in FIGS. 2B-C, if the customer is on their way, the field 230 can be represented in a third indicia, such as a grey or other neutral tone.

Still referring to the FIG. 2F, the user interface 224 includes a field 226A indicating a first order for the customer, along with an order number for the order. The field 226A can include a checkbox that can be selected when the employee wants to take an action with respect to the order indicated by the field 226A. For example, the employee can select the checkbox and then select control 233 to take one or more actions with respect to the selected order, such as indicating that the employee has taken ownership of completing the order and delivering it to the customer's vehicle.

Sub-fields 232A and 232B nested under the field 226A indicate where the purchased items for the order are located, or their hold locations. For example, the field 232A includes an indication of “SD007,” which can indicate that part of the order is located at a location defined by the number 7 at a hold area called service desk (SD). The hold area service desk can have multiple locations, aisles, or racks that can each be defined by an alphabetical character, a number, or another character. As an illustrative example, the service desk can include 10 locations (e.g., racks), each numbered from 1 to 10. The order represented by the field 226A includes 2 bags at location number 7 of the service desk hold area. The locations in the hold area can be arranged in order (e.g., from 1 to 10, from A to Z) in order to make it easy and efficient for the employee to find which location in the hold area to pick up a bag or bags for an order. The retail environment can have more than one hold area. For example, one or more other hold areas can include, but is not limited to, a mobile cart (MC), back room (BR), cooler (CLR), freezer (FRZ), dry grocery (DRY) and/or front of store (FOS). Each of these hold areas can have one or more locations, aisles, and/or racks as described above. Moreover, each of the fields 232A-N can be listed in order within a particular hold area. For example, the order represented by the field 226A includes bags in hold locations “SD007” and “SD008.” The fields 232A and 232B corresponding to these hold locations can be arranged in order (e.g., from smaller number to bigger number, alphabetical order), which can help the employee quickly navigate to the hold locations in the order by which they are arranged in the particular hold area.

The field 232A also includes indicators 234A and 234B for bags that are at the indicated location. In the example depicted, the field 232A indicates that there are 2 bags for the order located at location SD007, with each bag having 1 item. Similarly, field 232B includes indicator 234C indicating that 1 bags for the order is located at location SD008. The information in the fields 232A and 232B can ensure that the employee gathers the correct bags and number of bags to complete the customer's order.

In some implementations, multiple active orders can be associated with a single customer. For example, a customer may place a first order for drive-up fulfillment and later realize that they would like to purchase additional items and make a second order for drive-up fulfillment. Field 226N indicates a second active order associated with the customer John Smith. The field 226N, like the field 226A, includes a checkbox that functions in a similar manner described above. For example, the employee can select both checkboxes and to take actions with respect to both orders for the customer. Sub-field 232C nested under the field 226N indicates that the second order contains bags located at hold location “SD002” and sub-field 232N indicates that the second order also contains bags located at hold location “SD001.” The sub-field 232C also includes an indicator 234D indicating that there is 1 bag having 5 items for the second order is located at the hold location SD002. The sub-field 232N includes an indicator 234N indicating that 1 bag having 5 items for the second order is located at the hold location SD001.

In the example of FIG. 2F, the employee has not scanned any of the bags represented by the bag indicators 234A-N out of their respective hold locations. Therefore, all of the indicators 234A-N are presented in a first indicia, such as a black color. Moreover, the option 208 presented at the bottom of the user interface 224 is unselectable and greyed out. As described throughout this disclosure, the option 208 may not become selectable and another color, such as red, until all the bags for the order(s) have been scanned out of their hold locations and the indicators 234A-N have been updated to a second indicia, such as a green color.

FIG. 2G depicts the user interface 224 as the employee scans bags out of their respective hold locations for John Smit's order(s). Here, the field 230 has been updated to a red color, indicating that the customer is waiting for more than a threshold period of time. This can prompt the employee to work efficiently and quickly to complete the order. For the order represented by the field 226A, the employee has scanned the bag associated with the indicator 234A out of the hold location SD007. As a result, the indicator 234A is represented in the second indicia, such as the green colored bag. However, the bag associated with the indicator 234C needs attention, as the indicator 234C is now represented with a graphical element 235 such as a hazard symbol, yellow/orange triangle, and/or exclamation point. The graphical element 235 can be presented in the user interface 224 to bring the employees attention to the corresponding bag before completing the order. The graphical element 235 can be presented or overlaying a portion of the bag indicator 234C if an item or items in the respective bag have been cancelled from the order by the customer, recalled, etc. When the graphical element 235 is presented, the employee can select the indicator 234C to be presented with information about the respective bag. For example, the information can indicate a particular item(s) and quantity of the item(s) that has been cancelled in the respective bag. The employee can locate the bag in the fulfillment location (e.g., in a hold location) and remove the appropriate quantity of the item(s) from the bag. The employee can put the removed item(s) back in its respective location in the fulfillment location (e.g., on a shelf on a retail floor). The employee can also select an indication presented at the user interface 224 to confirm that the employee removed the quantity of the particular item(s) from the bag. Refer to FIGS. 2I-K for additional discussion.

FIG. 2H depicts the user interface 224 once the employee has scanned all the bags out of hold locations for the customers order(s). The field 230 still appears in the red color and the timer shows that the customer John Smith has been waiting longer since they arrived at the fulfillment location. The employee has scanned all the bags for the order represented by the field 226A, as shown by the bag indicators 234A-C appearing as green bags. The employee has also scanned all the bags for the order represented by the field 226N, as shown by the bag indicators 234D and 234N appearing as green bags. Because all the bags have been scanned for John Smith's orders, the option 208 can now appear selectable and in another indicia, such as having a red circular element 209. The employee can hold down on the red circular element 209 and swipe towards the right of the option 208. This action can cause the preparation to be completed for John Smith's orders. As previously described, by selecting the option 208, another user interface can be presented at the computing device 118 for the employee to input a 4-digit code or other identifier provided by the customer and used to verify the customer and complete delivery to that customer.

As shown in FIG. 2H, the bag indicator 234C still has graphical element 235, a hazard symbol. Although the bag associated with the bag indicator 234C has been successfully scanned, the graphical element 235 can remain in case another employee takes over to complete or otherwise deliver the order. The graphical element 235 can therefore notify the another employee to double check the contents of the bag associated with the bag indicator 234C before completing a task such as delivering the order to the customer. The graphical element 235 can be presented with any bag indicator 234A-N that has cancelled and/or recalled items and can remain presented even after the order is completed and delivered to the customer.

FIG. 2I depicts the user interface 224 when the employee selects one of the indicators 234A-N for a bag that has been scanned out of its hold location. Here, the employee has selected (e.g., tapped/clicked on) the indicator 234D for the bag held at location 232C (refer to FIG. 2H). As a result, a pop out window 236 overlays a bottom portion of the user interface 224. The rest of the user interface 224 may appear shaded or otherwise in a darker or lower lighting so that the employee can focus on information presented in the pop out window 236.

The pop out window 236 can present information such as a quantity of items in the selected bag, a hold location of the selected bag, a selectable graphical element depicting each item in the selected bag, information 238 about status of bag scanning, and a menu 240. The employee can click or tap the selectable graphical element to view a user interface with item information (e.g., an item listing that would be presented in an online retail environment to consumers). The information 238 can indicate whether the selected bag has been scanned out of the hold location. The information 238 can include a graphical element, such as a barcode with a checkmark overlaying it indicating that the bag has been scanned out of hold. The menu 240 can be clicked, tapped, or otherwise selected to view one or more actions that the employee can take to manually scan the bag out of the hold location, as described below in reference to FIGS. 2J-K.

FIG. 2J depicts the user interface 224 when the employee selects one of the indicators 234A-N for a bag that has not been scanned out of its hold location. For example, the server 116 described in FIG. 1 can receive, from the computing device 118 of the employee, an indication of user selection of an indication of a bag of the one or more bags presented in the user interface 224. The server 116 can then provide, to the computing device 118, information that, when processed by the computing device 118, causes the computing device 118 to display a pop out window 236 that overlays a portion of the user interface 224, the pop out window 236 including information about items in the selected bag, the information also including selectable options for completing a hold on the selected bag.

Here, the employee has selected the indicator 234D for the bag held at the location 232C (refer to FIG. 2H). However, unlike FIG. 2I, the pop out window 236 includes information 242. The information 242 indicates that the selected bag has not been scanned out of its hold location. The information 242 also includes a graphical element of a barcode with an X across it or another indicator indicating that the selected bag has not been scanned out of its hold location. The information 242 can prompt the employee to scan the bag to complete the hold. Therefore, the employee may manually scan the bag out of its hold location, such as when there is an issue reading or otherwise scanning labels on bags or the employee does not have a scanning device, using one of the selectable options from the menu 240.

FIG. 2K depicts selectable options from the menu 240 when the employee is completing a manual hold on the selected bag. Selecting or tapping on the menu 240 can cause a window 241 to appear over a portion of the pop out window 236. The window 241 can include one or more selectable options. Here, the window 241 includes options to “Remove from hold,” “Put back to hold,” and “Transfer hold.” One or more other options may also be presented in the window 241. In the example of FIG. 2K, the employee can select the option to “Remove from hold” in order to manually remove the selected bag from its hold location. Thus, the employee may select this option instead of scanning a label on the selected bag when removing the bag from its hold location. Selecting the option to “Remove from hold” can cause the indicator 234D for the bag to update to the second indicia, such as a green bag color, as shown in FIG. 2H.

Therefore, the server 116 can receive, from the computing device 118, an indication of user selection of an option from the selectable options to complete the hold on the selected bag. The server 116 can then provide, to the computing device 118, information that, when processed by the computing device 118, causes the computing device 118 to display the selectable option to complete the preparing of the order in the user interface 224 based on the user selection of the option to complete the hold on the selected bag.

FIG. 2L depicts a user interface 244 for displaying a report for out of hold orders. The out of hold orders report can be checked by employees to get a better sense of how the employees handle interactions and completion of orders with customers. The report can be checked daily. The report can also be checked multiple times throughout a day. The report can be accessed by selecting a menu option presented in the user interface 120. The menu option can be three horizontal lines outputted in a top left corner of the user interface 120, as shown in FIGS. 2D-E. From that menu option, the employee can select an option for “out of hold orders,” which can cause the user interface 244 to be presented at the computing device 118.

The report can list orders for customers who are on their way to the retail environment but have not shown up at the retail environment within a threshold amount of time to pick up their order(s). The orders listed in the report may already be scanned out of the hold locations by employees of the retail environment. Therefore, if a customer has not shown up to pick up their order within the threshold amount of time, their order can be added to the report shown in FIG. 2L. The customer's order can then be sorted in the report based on how recent the customer's order was scanned out of a hold location (or locations) by an employee.

The threshold amount of time can be 60 minutes. The threshold amount of time can be shorter or longer, in some implementations. For example, the threshold amount of time can be 30 minutes, 45 minutes, 80 minutes, 90 minutes, 120 minutes, 240 minutes, etc. One or more other threshold amounts of time can be used. The threshold amount of time can begin once the order has been successfully scanned out of a hold location by an employee in the retail environment. In some implementations, the threshold amount of time can begin once the customer provides an indication at their user device that they are on their way to the retail environment.

The user interface 244 can include selectable tabs 246 and 248. The tab 246 can be selected to view “Oldest” out of hold orders. The tab 248 can be selected to view “Newest” out of hold orders. Orders can be held for a predetermined hold window before they are cancelled because the customer does not show to pick up the order. The hold window can vary. For example, the hold window can be 3 days. In some implementations, the hold window can be shorter for certain types of items (e.g., grocery items, perishable goods, etc.) and longer for other types of items (e.g., non-perishable goods, electronics, etc.). In some implementations, the hold window can be 1 day, 2 days, 5 days, 7 days, or any other range of time. The hold window can begin from a time at which the order is successfully scanned out of a hold location. In some implementations, the hold window can begin once the customer has placed the order and paid for the items in the order. In yet some implementations, the hold window can begin once an employee has begun to prepare the order by scanning items out of hold locations.

The report shown when the tab 246 is selected can present orders sorted by oldest timestamp associated with a scanned out of hold action. As a result, orders that will be cancelled by the end of the current day (e.g., cancelling tonight) if the customer does not show up to pick up their order can be presented first in the report. This means that the orders that will be cancelled by the end of the current day have been scanned out of hold for approximately 3 days. Orders that will be cancelled by the next day (e.g., cancelling tomorrow) if the customer does not show can be presented second in the report. This means that the orders that will be cancelled by the next day have been scanned out of hold for approximately 2 days. Orders that will be cancelled in 2 or more days if the customer does not show can then be presented third in the report. This means that the orders that will be cancelled in more than 2 days have been scanned out of hold for approximately 1 day. The orders can remain scanned out of hold for 2 more days until the predetermined hold window of 3 days expires. Orders that have just been placed on the current day, for example, can be grouped into the category of cancelling in 2 or more days if the customer says they are on their way but have not shown up within the threshold amount of time.

The report shown when the tab 248 is selected can present the orders sorted by most recent timestamp associated with a scanned out of hold action. Therefore, orders that will be cancelled in more than 2 days if the customer does not show can be presented first, followed by orders that will be cancelled the next day if the customer does not show, and finally followed by orders that will be cancelled by the end of the current day if the customer does not show.

In the example of FIG. 2L, the employee has selected the tab 246. Since the tab 246 is selected the test “Oldest” on the tab is bolded and a red horizontal line (or other type of indicia) appears beneath the tab 246. Information can be presented in the tab 246 in one or more sub-fields 250A-N. For example, sub-field 250A can represent out of hold orders that are “cancelling tonight,” sub-field 250B can represent out of hold orders that are “cancelling tomorrow,” and sub-field 250N can represent out of hold orders that are “canceling in 2+ days,” as described above. Each of the sub-fields 250A-N can include text indicating what out of hold orders are associated with that sub-field and how many orders are associated. An employee can then select any of the orders to view order information presented in another GUI. The employee can also take an action on a selected order such as canceling the order (e.g., when the hold window of 3 days expires). The report can automatically update whenever orders are cancelled (or the customer shows up picks up the order). As an illustrative example, Syed Delta, which appears in the sub-field 250B to be cancelled the next day (“cancelling tomorrow”) can show up on the current day to pick up his order, even though he notified the retail environment that he was on his way 2 days ago. Once he picks up his order, the order can be marked as delivered/completed, and Syed Delta's order can be removed from the sub-field 250B in the report. On the other hand, if Syed Delta does not show up on the current day or the next day, his order can be automatically moved from the sub-field 250B for “Cancelling tomorrow” to the sub-field 250A for “Cancelling tonight.” If Syed Delta does not show up, then the order can be cancelled by an employee in the retail environment. Once Syed Delta's order is cancelled, his order may no longer appear in the report.

In some implementations, the employee can select an order listed in the listing of hold orders shown in the user interface 244 and select one or more controls to manually indicate that the order has been completed. For example, for the order for Syed Charlie, the order may have actually been completed (i.e., the employee or another employee successfully delivered the items for the order to Syed Charlie's vehicle) but a technological issue may have prevented the employee from automatically indicating to the system that the order was successfully completed. For example, wireless communication may have been temporarily unavailable at the time that the order was delivered to the customer. As another example, the scanner on the employee's device may have not been functioning properly, thus preventing the employee from scanning the delivered bags to complete the order. As another example, the dedicated application executing on the employees device may have frozen or crashed. As yet another example, the employee's device may have run out of power during or prior to completion of the delivery of the order. In such scenarios (and others), the employee can select one or more “Out of Hold” orders from the user interface 244 and select one or more controls to manually indicate that the order was successfully completed.

In some implementations, the user interface 244 can be integrated with one or more of the other user interfaces described herein such that the “out of hold” orders are displayed concurrently or as part of the same interface with other menu items such as pending orders that are in various stages of preparation (such as orders for customers that have indicated that they are on the way but have not yet surpassed one of the above described time thresholds). For example, the “out of hold” orders meeting the above described criteria that are shown in FIG. 2L can be displayed as part of the user interface 120 of FIG. 2A along with the other orders shown in FIG. 2A. The “out of hold” orders that satisfy the above described criteria (or other criteria for indicating that an order is late or has been “out of hold” for too long) can include one or more visual indicators to visually distinguish such orders from other orders. For example, “out of hold” orders can be displayed in a different color, with a distinctive pattern, with a distinctive icon, or other indicia. In some implementations, the “out of hold orders” can simply be displayed as part of submenu as part of the user interface 120 (or another interface) that is identified with a header, such as, for example “Out of Hold Orders” or other readily identifiable label to indicate the different status for such orders.

FIG. 2M depicts the user interface 224 when the employee decides to cancel an entire order. As mentioned above, the employee can cancel an order that they have claimed to prepare. After selecting a control to prepare a customer's order, the user interface 224 is presented at the computing device 118. The field 230 indicates that the customer John Smith is on his way to the fulfillment location. The employee can select any of the checkboxes next to orders presented in the user interface 224 then click (e.g., select, tap on) a menu option 252.

FIG. 2N depicts the user interface 224 with selectable options to manage an order presented therein. By clicking on the menu option 252 in FIG. 2M, a window 254 can be presented to overlay a portion of the user interface 224. The window 254 can include one or more selectable options for actions that can be taken for an order or orders. In FIG. 2N, the employee selected a checkbox next to an order represented by sub-field 255 in the user interface 224. The window 254, which appears once the employee selects the menu option 252 (shown in FIG. 2M), lists three actions for the selected order: “Cancel orders,” “Order notes,” and “Put all bags to hold.” Here, the employee can select the action to “Cancel orders,” which can cause the entire order represented by the sub-field 255 to be cancelled.

FIG. 2O depicts the user interface 224 once the employee selects the action to “Cancel orders” described in FIG. 2N. Once the employee selects the action to “Cancel orders,” a pop out window 256 can appear over a portion of the user interface 224. The rest of the user interface 224 can be presented in a darker shade or lighting so as to focus the employee's attention on information presented in the pop out window 256. The pop out window 256 can present selectable options as reasons for canceling the selected order (or orders). For example, the employee can select reasons that include “Guest request,” “Ring up at POS,” or “Other.” One or more other reasons can also be presented in the pop out window 256.

The employee can select “Guest request” if the customer requests to cancel the order and/or the customer cancels the order from their device. By selecting this reason, the employee may then return items for that order to locations on a sales floor. The employee can select “Ring up at POS” if the employee intends to ring the entire order up at a POS in the fulfillment location instead of bringing the entire order out to the customer's vehicle. This can occur, for example, when the order cannot be completed through a mobile application presented at the customer's device (e.g., the customer's payment information may not be accepted at the mobile application, the customer may not have payment information available to input at the mobile application, the mobile application does not allow completion/payment of the order, etc.). The employee can select “Other” if another reason exists for canceling the order. For example, if an item from the order or the entire order is damaged, the order may be cancelled. The item or the entire order can be damaged when an employee is scanning the item or entire order out of hold locations. Damage may also occur when the order is being prepared. In some implementations, damage can occur when the order is being delivered, which causes the order to be cancelled (e.g., the employee can be bringing a bag of glass bottles out to the customer's vehicle, the bag can break, and the glass bottles can hit the pavement and break into pieces). Damage to an item or the entire order can also occur in one or more other scenarios. In some implementations, the employee may be prompted to provide input designated what the other reason is for canceling the order.

FIG. 2P depicts the user interface 224 once an order cancellation is completed. Once the employee selects a reason for canceling the order, as described in FIG. 2O, a window 258 can be presented over a portion of the user interface 224 indicating that the order was successfully cancelled. The employee can click on “Ok” presented in the window 258 to close out of the window 258 and return to the user interface 224. In some implementations, once the order is successfully cancelled, hold location information may disappear from the user interface 224 but items may still be viewable.

FIG. 2Q depicts the user interface 224 when the employee chooses to cancel multiple orders at once. Referring back to the FIGS. 2M-N, the employee may not select any of the checkboxes for orders presented in the user interface 224. Instead, the employee may just select the menu option 252 and click on the option to “Cancel orders” in the window 254. Selecting the option “Cancel orders” when no checkboxes have been selected for orders in the user interface 224 can cause a pop out window 260 to appear over a portion of the user interface 224, as shown in FIG. 2Q. The pop out window 260 shown in FIG. 2Q can provide the employee with selectable checkboxes for all orders 262A-N associated with the customer John Smith in the user interface 224. The employee can select multiple checkboxes to cancel multiple orders at once. For example, the employee has selected the checkboxes for the orders 262A and 262N. The employee can then select a control 264, such as a button, to cancel the selected orders at once.

FIG. 2R depicts the user interface 224 for canceling an item in an order. Here, the employee can select the bag indicator 234C in the hold location 232B for the order represented by the sub-field 226A. Selecting the bag indicator 234C can cause information about the selected bag to be displayed in the user interface 224, as described in reference to FIG. 2S.

FIG. 2S depicts the user interface 224 with information about the bag that was selected in FIG. 2R. When the employee selects the bag indicator 234C in FIG. 2R, a pop out window 266 can overlay a portion of the user interface 224, as shown in FIG. 2S. The pop out window 266 can include information about the selected bag, as described in reference to FIGS. 2I-K. As previously mentioned, the pop out window 266 can include a selectable graphical element 268 for each item in the selected bag. Here, the selected bag contains 5 of the same item. Thus, the pop out window 266 includes the graphical element 268 for all 5 items. The graphical element 268 can be a tile with an image of the item, a title for the item, an item identifier (e.g., barcode, SKU, etc.), and one or more other information about the item. Selecting (e.g., clicking, tapping) the graphical element 268 can cause additional information about the item to be presented at the computing device 118, as described in FIG. 2T.

FIG. 2T depicts a window 270 that can be presented at the computing device 118 when the employee selects the graphical element 268 representing an item(s) in the selected bag shown in FIG. 2S. The window 270 can be presented over an entire portion of a display screen of the computing device 118. In some implementations, the window 270 can be presented to overlay a portion of the user interface 224, like the pop out window 266 depicted and described in FIG. 2S.

The window 270 can include information about the selected item, including an image of the item, a price of the item, a quantity of the item for the particular order, a title of the item, and a control 272. The control 272 can be a button with text indicating “Cancel items.” The control 272 can be clicked (e.g., tapped, selected) by the employee to cancel the items from the order presented in the window 270. In some implementations, clicking on the control 272 can cause a pop out window to be displayed that prompts the employee to confirm the quantity of the item that is going to be cancelled. The employee can confirm the quantity and then remove those items from the bag and put the items back on a sales floor so that the cancelled items are not delivered to the customer. Moreover, in some implementations, if the employee reviews contents of the selected bag and determines that the selected items are missing from the bag, the employee can click on the control 272 to cancel the selected items.

FIG. 2U depicts the user interface 224 with a pop out window 274 indicating that an item or items were successfully cancelled. Once the employee clicks the control 272 and confirms the quantity of items being cancelled in FIG. 2T, the pop out window 274 depicted in FIG. 2U can be presented at the computing device 118. The window 270 can be replaced with the user interface 224 and the pop out window 274 displayed over a portion of the user interface 224. The pop out window 274 can indicate that “Items were successfully cancelled.” The employee can then click on an “Ok” presented in the pop out window 274 to close out of the window 274 and return to the user interface 224.

FIG. 2V depicts the user interface 224 when an order has a partial cancel. A partial cancel occurs when one of a multiple quantity of an item is being cancelled (e.g., at the customer's request or by the employee). For example, if the customer ordered 5 of the same towels but realized that they only need 4 towels, 1 towel can be cancelled from the total quantity of towels that were ordered. As another example, if the employee is preparing an order for 5 of the same towels but realizes during preparation that 2 of the towels are ripped, the employee can cancel the 2 ripped towels but still prepare the remaining 3 towels in the order. The user interface 224 can include a sub-field 275 for an order having a partial hold. The sub-field 275 can further include an indicator 276 for a bag associated with the order having the partial hold. The indicator 276 can be a graphical element of a bag including a numeric value indicating a quantity of items in the bag. The indicator 276, as shown in FIG. 2V, may also include a symbol such as a hazard symbol, yellow/orange triangle, and/or an exclamation point to focus the employee's attention on the bag having the partial hold. Thus, the symbol can indicate that the bag contains at least one item having an issue. Selecting the indicator 276 can cause additional information to be presented in the user interface 224, as described in reference to FIG. 2W.

FIG. 2W depicts the user interface 224 with additional information about an order having a partial hold. As mentioned in FIG. 2V, the employee can select the indicator 276 for the bag having the partial hold, which can cause a pop out window 278 to overlay over a portion of the user interface 224, as shown in FIG. 2W. The pop out window 278 can indicate that a particular item in the bag has been cancelled by an employee (“TM cancelled”). As an illustrative example, this type of partial cancel can occur if the employee accidentally broke 1 of 4 glasses of a same type while preparing the order. The pop out window 278 can also indicate that a particular item in the bag has been cancelled by the customer. As an illustrative example, this type of partial cancel can occur if the customer decides that they want less than all of a same type of item for which they placed the order.

The pop out window 278 can include a selectable control 280 to “Remove cancelled item” from the bag. The employee can select the control 280 and physically remove the item that was cancelled by the guest from the bag.

Once all the items that have been cancelled by the guest are removed from the bag, the indicator 276 described in FIG. 2V can be updated from a black or grey bag to a green bag. The employee can then proceed with continuing and completing the order presented in the user interface 224.

FIG. 2X depicts the user interface 224 with additional information about an order having a partial hold. As mentioned in FIGS. 2V-W, the employee can select the indicator 276 for the bag having the partial hold, which can cause a pop out window 282 to overlay a portion of the user interface 224, as shown in FIG. 2X. The pop out window 282 is similar to the pop out window 278 described in FIG. 2W. In the example of FIG. 2X, the pop out window 282 indicates multiple different items that have been cancelled by the customer. The pop out window 282 can also include information 284 indicating that the employee should scan the bag to complete the hold (e.g., perform a manual hold). The employee can select menu option 286 to be presented a window 288 having selectable options for manually removing the bag from hold. The window 288 can include options for “Remove from hold,” “Put back to hold,” and “Transfer hold.” The employee can select the option to “Remove from hold,” which can cause the pop out window 278 described in FIG. 2W to be presented at the computing device 118. Thus, the employee may remove the items that were cancelled by the customer from the bag that has been manually removed from hold. In some implementations, selecting the option to “Remove from hold” can cause a pop out window 290 shown in FIG. 2Y to be presented at the computing device 118.

FIG. 2Y depicts the user interface 224 with the pop out window 290 for shopping items that have been cancelled by the customer. As mentioned above, if multiple items are cancelled by the customer, the pop out window 290 can be presented to the guest at the computing device 118. The pop out window 290 can indicate whether the cancelled items should be reshopped. Reshopping requires an employee to return the cancelled items to their respective locations in the retail environment. The cancelled items can, for example, be returned to their designated shelves or other locations on a sales floor of the retail environment. If a cancelled item is to be reshopped, the employee can remove the cancelled item from a bag for the customer and add or put the cancelled item in a cart (e.g., a physical shopping cart or other type of physical cart maneuvered around the retail environment by employees) to then go back onto the sales floor. Items that are cancelled because they are faulty, broken, or damaged may not be reshopped. Cancelled items that are perishable or otherwise no longer satisfy food safety guidelines may not be reshopped (e.g., an item that is supposed to be refrigerated but has been left out of a cooler for longer than a threshold amount of time indicated in the food safety guidelines). In the example of FIG. 2Y, the pop out window 290 indicates that “An RTS task will not occur for this cancellation,” which means that the cancelled item does not have to be reshopped.

As described throughout this disclosure, once all the cancelled items have been removed from the bag or bags, the employee can continue with completing preparation and/or delivery of the order to the customer.

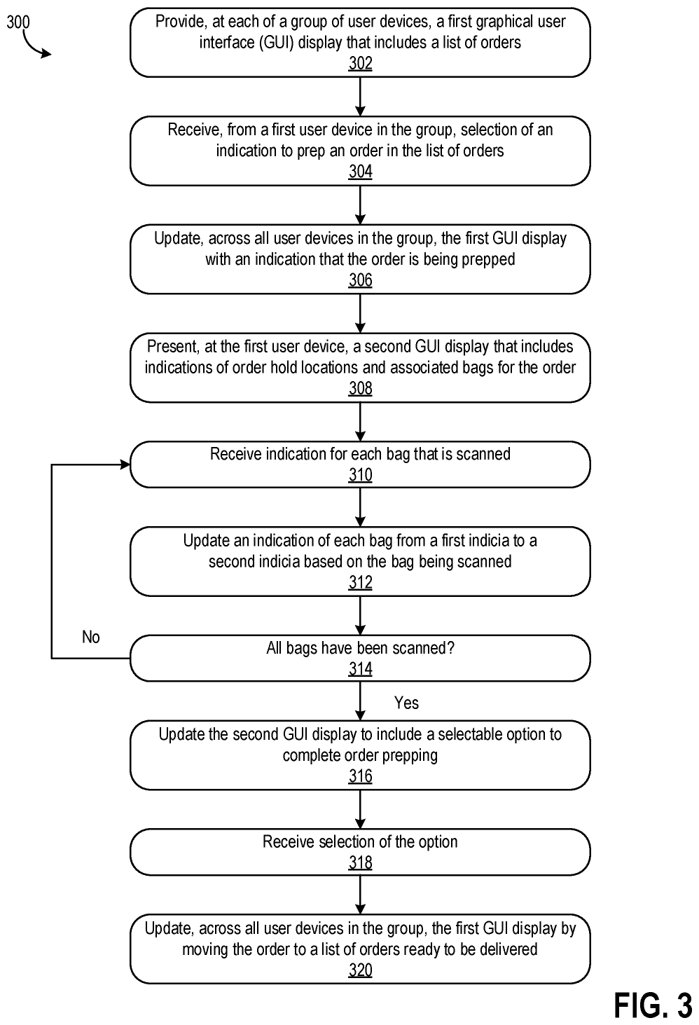

FIG. 3 is a flowchart of a process 300 to be performed by one or more computing devices in a drive-up fulfillment system when a user prepares an order for a drive-up customer. The process 300 can be performed by the server system 116 depicted and described in reference to FIG. 1. The process 300 can also be performed by any of the computing devices 118 of employees in the fulfillment location. The process 300 can also be performed by one or more other computing systems, devices, computers, networks, cloud-based systems, and/or cloud-based services. For illustrative purposes, the process 300 is described from the perspective of a server.

Referring to the process 300 in FIG. 3, the server can provide, at each of a group of user devices, a first graphical user interface (GUI) display that includes a list of orders in block 302. In other words, the server can provide, to each of the group of user devices, information that, when processed by each of the group of user devices, causes each of the group of user devices to display the first GUI, the first GUI including a list of orders for customers for fulfillment at a fulfillment location. Orders in the list of orders for customers for fulfillment at the fulfillment location can be ranked and presented in the first GUI from least amount of time remaining before arrival at the fulfillment location to most amount of time remaining before arrival at the fulfillment location. The user devices can include the computing devices 118 of employees in the fulfillment location, as described throughout this disclosure. The list of orders can include orders grouped into a first category for customers who have arrived and a second category for customers who are on their way to the fulfillment location. In other words, the list of orders for customers for fulfillment at the fulfillment location can include a first sub-list of at least one order in the list of orders for customers that arrived at the fulfillment location and a second sub-list of at least one order in the list of orders for customers that are on their way to the fulfillment location. Refer to FIGS. 1 and 2A for additional discussion about the first GUI display.

The server can receive, from a first user device in the group, selection of an indication to prep an order in the list of orders in block 304. For example, the server can receive, from the first user device of the group of user devices, an indication of user selection of a first control of the first GUI indicating an intention to prepare the order in the list of orders. As described in reference to FIGS. 1 and 2A, each order in the list of orders can include a control, such as a button, that can be selected by any employee at their device to claim a task of preparing that order. An employee at the first user device can, for example, select the control to claim preparing a particular order. This user selection can be transmitted to the server in block 304.

In block 306, the server can update, across all user devices in the group, the first GUI display with an indication that the order is being prepped. In some implementations, the server can provide, to at least a subset of the group of user devices, instructions to update the first GUI such that the first GUI includes the indication that the order is being prepared. This update can be made in real time or near real time. As a result, all the other employees in the fulfillment location (or at least the employees in the group) can be made aware that the particular order has been claimed by the employee at the first device. Moreover, the indication that the order is being prepped can include an identifier of a user associated with the first user device. In the example of FIG. 3, the user can be an employee named “Jane Doe” and the identifier can be the employee's name, or a portion of their name (e.g., Jane, Jane D., J. D., etc.). The identifier can also be an employee ID that may be assigned to the employee when working at the fulfillment location. Refer to FIG. 2A for additional discussion about the indication that the order is being prepped.

The server can also present, at the first user device, a second GUI display that includes indications of order hold locations and associated bags for the order (block 308). For example, the server can provide, at the first user device in the group of user devices, information that, when processed by the first user device cause the first user device to display the second GUI, the second GUI including indications of one or more order hold locations in the retail information and one or more bags associated with each of the one or more order hold locations for the selected order to be prepared. The indications of each bag can include a numeric value graphically displayed in a bag icon, the numeric value indicating a quantity of items in the bag. Refer to FIG. 2B for additional discussion about the second GUI display. Moreover, block 308 can be performed before, during, or after block 306 is performed.

The server can receive an indication for each bag that is scanned in block 310. In other words, the server can receive, from the first user device, information indicating identifying information for one or more of the bags associated with the order. The information indicating identifying information for one or more of the bags associated with the order can include indications for the one or more of the bags that are scanned by the first user device at the fulfillment location. As another example, the information indicating identifying information for one or more of the bags associated with the order can include indications for the one or more of the bags that are scanned by a scanning device communicably coupled to the first user device at the fulfillment location. Sometimes, the information indicating identifying information for one or more of the bags associated with the order can include indications for the one or more of the bags that are scanned by a scanning device located at the fulfillment location. In yet some implementations, the information indicating identifying information for one or more of the bags associated with the order can include alphanumeric identifiers for the one or more of the bags that are inputted by a user at the first user device at the fulfillment location. Therefore, the employee can use scan the bags using a variety of techniques. The employee can use the first user device to scan the bags associated with the order. Each scan can be registered at the first user device and transmitted to the server. In some implementations, the employee may use a scanning device in the fulfillment location instead of a camera or other scanning device of their first user device to scan each of the bags for the order.

The server can update an indication of each bag from a first indicia to a second indicia based on the bag being scanned in block 312. Thus, the server can provide, to the first user device, instructions to update the second GUI such that the indications of each bag associated with the order to be prepared is updated from the first indicia to the second indicia based on the respective associated bag having been identified by the identifying information for the one or more of the bags associated with the order received by the server in block 310. For example, the server can receive indications (e.g., user input) from the first user device indicating that the employee scanned a barcode or other identifier (e.g., label) on each bag associated with the order. The server can match the scanned barcode or other identifier with the indications of the bags in the second GUI to determine which indications to update from the first indicia to the second indicia. As described throughout this disclosure, the first indicia can be a grey or black bag and the second indicia can be a green bag. Therefore, whenever a bag is scanned, the indication for that bag can be updated from grey or black to green, thereby demonstrating to the employee that the bag has been successfully scanned for the order. Refer to FIG. 2C for additional discussion.

The server can also determine whether all the bags for the order have been scanned in block 314. As described above, the server can keep track of which bags are scanned for the order and which bags remain to be scanned. If all the bags have not been scanned, the server can return to block 310 and continue to receive indications that the bags are scanned until all the bags have been scanned. If all the bags have been scanned in block 314 (and thus their indications are updated to the second indicia in the second GUI display), the server can proceed to block 316. Refer to FIG. 2H for additional discussion.

In block 316, the sever can update the second GUI display to include a selectable option to complete order prepping. In some implementations, the server can provide, to the first user device, instructions to update the second GUI to include the selectable option to complete the preparing of the order based on a determination that identifying information for each bag associated with the order has been received by the server. The selectable option to complete the preparing of the order can be presented in the second GUI and non-selectable until each bag has been scanned. Thus, the option can be presented in the second GUI display since block 308. However, the option may be greyed out and thus unselectable until the server determines that all the bags have been scanned for the order. Thus, once this determination is made, the option can become selectable and updated to another indicia other than being greyed out. For example, the option can include a circular graphical element that can be presented in a red color in block 316. Refer to FIG. 2H for additional discussion about the selectable option for completing preparation of the order.

The server can receive selection of the option in block 318. For example, the server can receive, from the first user device, an indication of selecting the option to complete the preparing of the order. As mentioned above, the employee can hold down on the circular graphical element and slide to a right of the second GUI display to complete preparing the order. This user input can be received by the server in block 318, thereby marking the employee's completion of the preparing stage for the order.

In block 320, the server can update, across all user devices in the group, the first GUI display by moving the order to a list of orders ready to be delivered. This update can be made in real time or near real time. For example, the server can provide, to at least the subset of the group of user devices, instructions to update the first GUI by removing the order from the list of orders and adding the order to a second list of orders ready to be delivered. As a result, the other employees in the fulfillment location can see that the order's preparation has been completed and now the order can be delivered to the customer. The employees can view the list of orders ready to be delivered any select a control near an order in this list to claim a task of delivering that order to the customer. Refer to FIGS. 2D-E and 4 for additional discussion about the delivering stage.

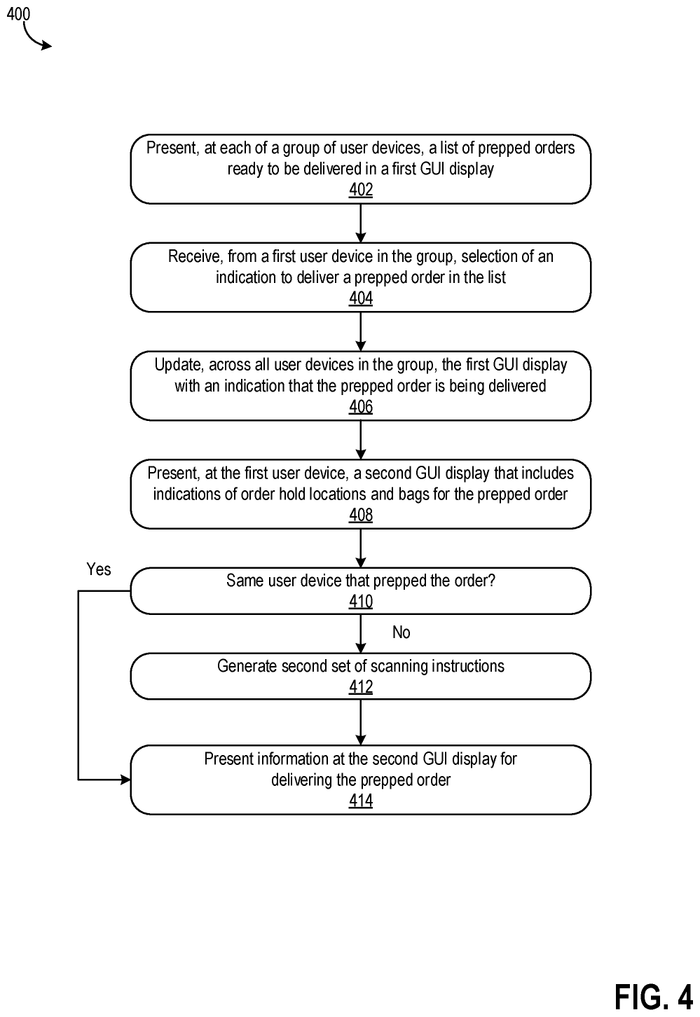

FIG. 4 is a flowchart of a process 400 to be performed by one or more computing devices in a drive-up fulfillment system when a user delivers an order to a drive-up customer. The process 400 can be performed by the server system 116 depicted and described in reference to FIG. 1. The process 400 can also be performed by any of the computing devices 118 of employees in the fulfillment location. The process 400 can also be performed by one or more other computing systems, devices, computers, networks, cloud-based systems, and/or cloud-based services. For illustrative purposes, the process 400 is described from the perspective of a server.

Referring to the process 400 in FIG. 4, the server can present, at each of a group of user devices, a list of prepped orders ready to be delivered to customers in a first GUI display in block 402. In some implementations, the server can provide, to each of at least the subset of the group of user devices, information that, when processed by each of the at least the subset of the group of user devices, causes each of the at least the subset of the group of user devices to display the first GUI with a list of orders ready to be delivered. Refer to FIGS. 2D-E for additional discussion about the list of prepped orders ready to be delivered to customers.

In block 404, the server can receive, from a first user device in the group, selection of an indication to deliver a prepped order in the list. The first user device described in block 404 can be the same or different first user device described in the process 300 in FIG. 3. For example, the server can receive, from a second user device of the at least the subset of the group of user devices, an indication of user selection of a second control of the first GUI indicating an intention to deliver a prepared order in the list of orders ready to be delivered. The second user device can be operated by an employee who did not operate the first user device and thus did not prepare the order that now appears in the list of orders ready to be delivered.

Next, the server can update, across all the user devices in the group, the first GUI display with an indication that the prepped order is being delivered (block 406). The update can be performed in real time or near real time so that the other employees can become aware that the order is being delivered and thus the employees should not (nor can they) take on the task of delivering that order (unless the task of delivering the order is cancelled, as described further below). In some implementations, the server can provide, to each of at least the subset of the group of user devices, instructions to update the first GUI to include an indication that the prepared order is being delivered. The indication that the prepared order is being delivered can include an identifier for a user (e.g., the employee) associated with the second user device, as also described in reference to the process 300 in FIG. 3. Additionally, refer to FIGS. 2D-E for additional discussion about updating the first GUI display across the user devices in the group.

In block 408, the server can present, at the first user device, a second GUI display that includes indications of order hold locations and bags for the prepped orders. In some implementations, the second GUI display in block 408 can be the same as the second GUI display described in the process 300 of FIG. 3. Block 408 can also be performed before, during, or after block 406. The second GUI display can be presented at the first user device so that the employee can check/verify the bags, and items for each of the bags, associated with the order they will be delivering to the customer. The employee can make sure that all the bags for the order have been scanned out of their respective hold locations. The employee may also check whether any items in the bag(s) require attention (e.g., the items have been cancelled, recalled, etc.). Refer to FIGS. 2F-K for additional discussion.

In block 410, the server can determine whether the same user device that prepared the order now selected the indication to deliver the order. Sometimes, block 410 can be performed before block 408. If the user device is the same, then the server can proceed to block 414 described below. If the user device is different, then the server can generate a second set of scanning instructions in block 412. Refer to blocks 310-316 in the process 300 of FIG. 3 for additional discussion about scanning the bags for the order. Then the server can proceed to block 414.

In block 414, the server can present information at the second GUI display for delivering the prepped order to the customer. As described above, the information can include an input field to enter and/or scan a 4-digit barcode or other identifier associated with the customer. This information can be used to verify and confirm delivery of the bags to the customer associated with the order. The information may also include identifying information about the customer's vehicle, such as color, year, make/model, and/or parking spot outside the fulfillment location. One or more other information can be presented at the second GUI display to facilitate delivery and completion of delivery of the order to the associated customer.

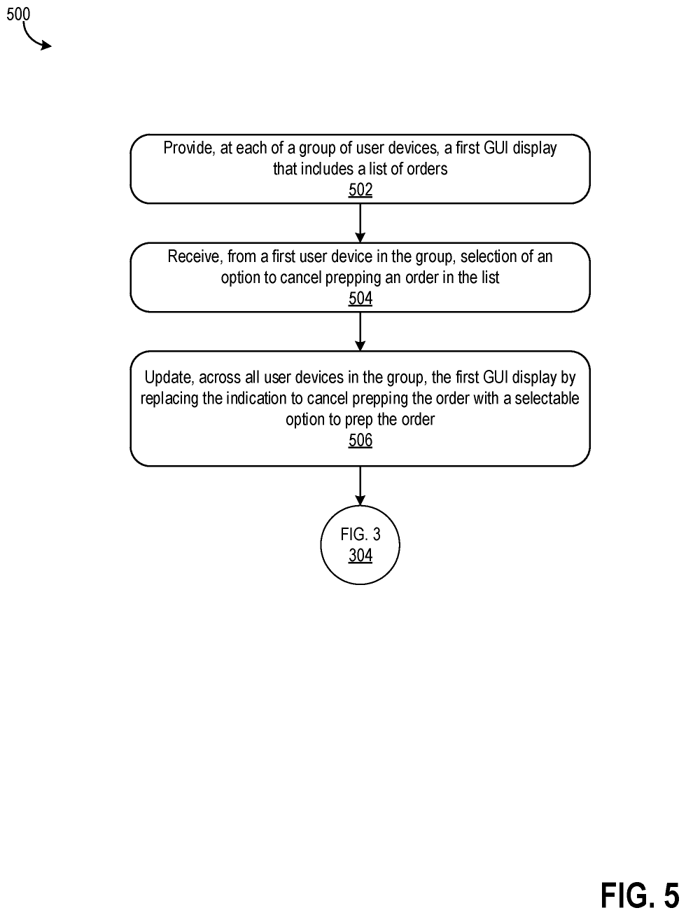

FIG. 5 is a flowchart of a process 500 to be performed by one or more computing devices in a drive-up fulfillment system when a user stops preparing an order for a drive-up customer. The process 500 can be performed by the server system 116 depicted and described in reference to FIG. 1. The process 500 can also be performed by any of the computing devices 118 of employees in the fulfillment location. The process 500 can also be performed by one or more other computing systems, devices, computers, networks, cloud-based systems, and/or cloud-based services. For illustrative purposes, the process 500 is described from the perspective of a server.

Referring to the process 500, the server can provide, at each of a group of user devices, a first GUI display that includes a list of orders in block 502. The list of orders can be the list of orders to be prepared, as described in block 302 in the process 300 of FIG. 3. In some implementations, the list of orders may also be the list of orders to be delivered that is described in block 402 in the process 400 of FIG. 4. Refer to FIG. 1 for additional information about the first GUI display.

In block 504, the server can receive, from a first user device in the group, selection of an option to cancel preparing an order in the list. For example, the server can receive, from the first user device, an indication of user selection of a third control of the first GUI to cancel the preparing of the order. As shown in FIG. 1, in some implementations a control, such as a button can appear with an order that is currently being prepared by an employee. The control can include text indicating “Cancel prep.” By selecting this control, the employee (whether it's the same employee who is preparing the order or another employee in the group) can confirm canceling the task of preparing the order so that another employee in the group can claim the task of preparing that order.

Moreover, in some implementations, the first device described in block 504 can be the same as the first device described in FIGS. 3 and/or 4. In some implementations, the first device described in block 504 can be different than the first device described in FIGS. 3 and/or 4.

The server can then update, across all user devices in the group, the first GUI display by replacing the indication to cancel prepping the order with a selectable option to prep the order (block 506). In some implementations, the update can be made across at least a subset of the group of user devices. For example, the server can provide, to at least the subset of the group of user devices, instructions to update the first GUI by replacing the third control to cancel the preparing of the order with the first control to prepare the order. The update can be made in real and/or near real time. Refer to FIGS. 2A and 2D for additional discussion.

The server may proceed to block 304 in the process 300 of FIG. 3, in which a user device in the group selects the indication to prep the order. The server can then continue through the process 300 described above in FIG. 3. In such a scenario, the user device that selects the indication to prep the order can be different than the first user device in block 504 that cancels preparation of the order.

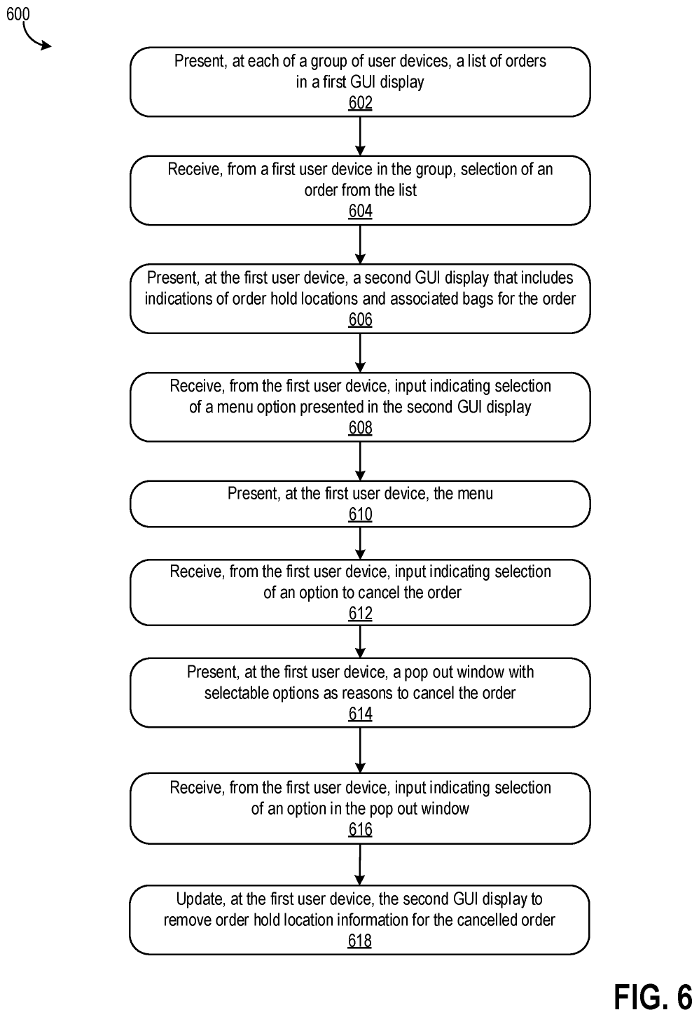

FIG. 6 is a flowchart of a process 600 to be performed by one or more computing devices in a drive-up fulfillment system when a user cancels an order for a drive-up customer. More particularly, the process 600 can be performed when an employee cancels an order from a GUI that displays information about that order. The process 600 can be performed by the server system 116 depicted and described in reference to FIG. 1. The process 600 can also be performed by any of the computing devices 118 of employees in the fulfillment location. The process 600 can also be performed by one or more other computing systems, devices, computers, networks, cloud-based systems, and/or cloud-based services. For illustrative purposes, the process 600 is described from the perspective of a server.

Referring to the process 600, the server can present at each of a group of user devices, a list of orders in a first GUI display in block 602. Refer to the discussion of block 502 in the process 500 of FIG. 5 for additional discussion.

In block 604, the server can receive, from a first user device in the group, selection of an order from the list. As described throughout this disclosure, the first user device may be the same or different than the first user device described in the processes 300, 400, and/or 500 in the respective FIGS. 3, 4, and/or 5. Selection of the order can include clicking or tapping on a customer's name for the order and/or clicking or tapping a control, such as a button, that appears with the order in the list. The control can indicate that the order is ready to be prepped. The control can also indicate that the order can be cancelled.

In block 606, the server can present, at the first user device, a second GUI display that includes indications of order hold locations and associated bags for the order. Refer to block 308 in the process 300 of FIG. 3 and block 408 in the process 400 of FIG. 4 for additional discussion about the second GUI display. Moreover, as shown in FIG. 2M, the second GUI display can also include a selectable menu option.

Accordingly, in block 608, the server can receive, from the first user device, input indicating selection of a menu option presented in the second GUI display. Therefore, from the second GUI display, the employee can tap on the menu option to view actions that can be taken for the order displayed in the second GUI display. Refer to FIG. 2M for additional discussion.

The server can present, at the first user device, the menu with one or more selectable options in block 610. The selectable options can include, but are not limited to, “Cancel orders,” “Order notes,” and “Put all bags to hold.” One or more other options may also be presented in the menu of options for user selection. Refer to FIG. 2N for additional discussion.

The server can receive, from the first user device, input indicating selection of an option to cancel the order (block 612). Refer to FIG. 2N.

The server can also present, at the first user device, a pop out window with selectable options as reasons to cancel the order in block 614. As depicted and described in FIG. 2O, the pop out window can include one or more selectable options including, but not limited to, “Guest request,” “Ring up at POS,” and “Other.” One or more other reasons for cancelling the order can also be presented in the pop out window. In some implementations, the pop out window may not be presented and block 614 can be skipped in the process 600. In such a scenario, the employee can simply select the option from the menu to cancel the order, confirm the cancellation, and then the process 600 can end.

The server can receive, from the first user device, input indicating selection of an option in the pop out window (block 616).

Then, the server can update, at the first user device, the second GUI display to remove order hold location information for the cancelled order (block 618). Refer to FIG. 2P for additional discussion.

Moreover, in some implementations, as depicted and described in FIG. 2Q, the employee can cancel multiple orders at a time from the second GUI display. For example, the employee can select the menu option to be presented with the list of menu options. The employee can select the option to cancel orders. A pop out window can then appear over a portion of the second GUI display that prompts the employee to select which orders to be cancelled for the particular customer. The employee can provide their selection as input by clicking a checkbox next to each order to be cancelled. The employee can then select a control, such as a button, to cancel the selected orders. The second GUI display can then be updated to remove order hold location information for the cancelled orders and the process 600 can end.

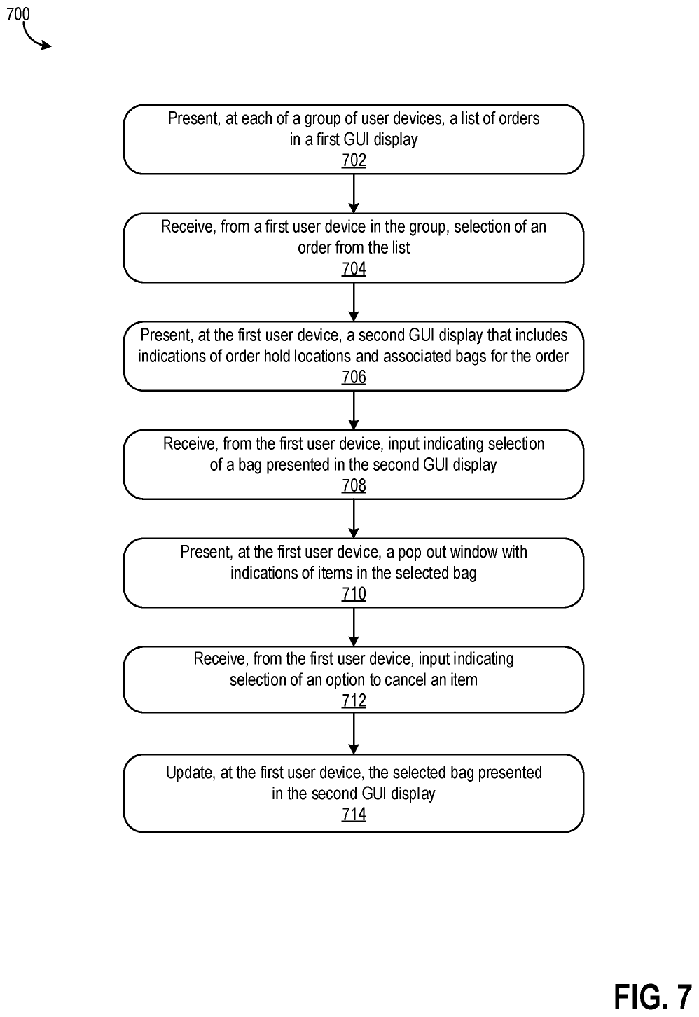

FIG. 7 is a flowchart of a process 700 to be performed by one or more computing devices in a drive-up fulfillment system when a user cancels an item in an order for a drive-up customer. More particularly, the process 700 can be performed when an employee cancels at least one item in a customer's order. The process 700 can be performed by the server system 116 depicted and described in reference to FIG. 1. The process 700 can also be performed by any of the computing devices 118 of employees in the fulfillment location. The process 700 can also be performed by one or more other computing systems, devices, computers, networks, cloud-based systems, and/or cloud-based services. For illustrative purposes, the process 700 is described from the perspective of a server.

Referring to the process 700, the server can present, at each of a group of user devices, a list of orders in a first GUI display (block 702). Refer to the discussion of block 502 in the process 500 of FIG. 5 for additional discussion.

In block 704, the server can receive, from a first user device in the group, selection of an order from the list. As described throughout this disclosure, the first user device may be the same or different than the first user device described in the processes 300, 400, 500, and/or 600 in the respective FIGS. 3, 4, 5, and/or 6. Selection of the order can include clicking or tapping on a customer's name for the order and/or clicking or tapping a control, such as a button, that appears with the order in the list. The control can indicate that the order is ready to be prepped. The control can also indicate that the order can be cancelled.

In block 706, the server can present, at the first user device, a second GUI display that includes indications of order hold locations and associated bags for the order. Refer to block 308 in the process 300 of FIG. 3 and block 408 in the process 400 of FIG. 4 for additional discussion about the second GUI display. In some implementations, when an item or items are cancelled by the customer or another employee, the bag associated with the cancelled item(s) can be presented in a different indicia. For example, the server can provide, to the first user device, information that, when processed by the first user device, causes the first user device to display a third indicia partially overlaying an indication of a bag of the one or more bags based on a determination, by the server, that an issue exists with an item in the bag. The issue can include at least one of the item being cancelled and/or being recalled. The third indicia can be at least one of a hazard symbol, a triangle, and/or an exclamation point. Refer to FIGS. 2G-K for further discussion about presenting the indication of the bag with the third indicia.

The server can receive, from the first user device, input indicating selection of a bag presented in the second GUI display in block 708. In the abovementioned example, the employee can select the indication of the bag having the third indicia. After all, the third indicia can indicate that there is an issue with an item or items in the corresponding bag. The item or items in the corresponding bag might have been cancelled by the customer.

The server can then present, at the first user device, a pop out window with indications of items in the selected bag (block 710). The indications can include visuals, such as images, of each type of item in the bag. The indications can also include text, such as titles, prices, and/or quantities of each item in the bag. Refer to FIGS. 2I, 2J, 2S-T, and 2W-X for additional discussion about indications of the items presented in the pop out window.

The server can receive, from the first user device, input indicating selection of an option to cancel an item (block 712) The option can be presented in the pop out window or accessible from a menu option presented in the pop out window (block 712). For example, as shown in FIG. 2T, the indications in the pop out window can include a selectable control to cancel items. The employee can select that control to cancel a particular item or items. As another example, shown in FIGS. 2V-W, when the customer (or another employee, in some instances) cancels an item, the indication of the item can include text such as “TM cancelled.” This text can notify the employee that the item has been cancelled. Therefore, the employee can select a control to remove the cancelled item from the selected bag so that the bag can be prepared and delivered to the customer without the cancelled item.

Based on the input, the server can update, at the first user device, the selected bag presented in the second GUI display (block 714). For example, the indication of the selected bag can have a different numeric value therein that now represents how many items are in the bag once the cancelled items are removed. As another example, the indication of the selected bag can be changed from a first indicia, such as a grey or black bag icon, to a second indicia, such as a green bag icon. As yet another example, the indication of the selected bag can now be presented without the third indicia (e.g., the hazard symbol) to demonstrate that the issue that was identified for the selected bag has been responded to.

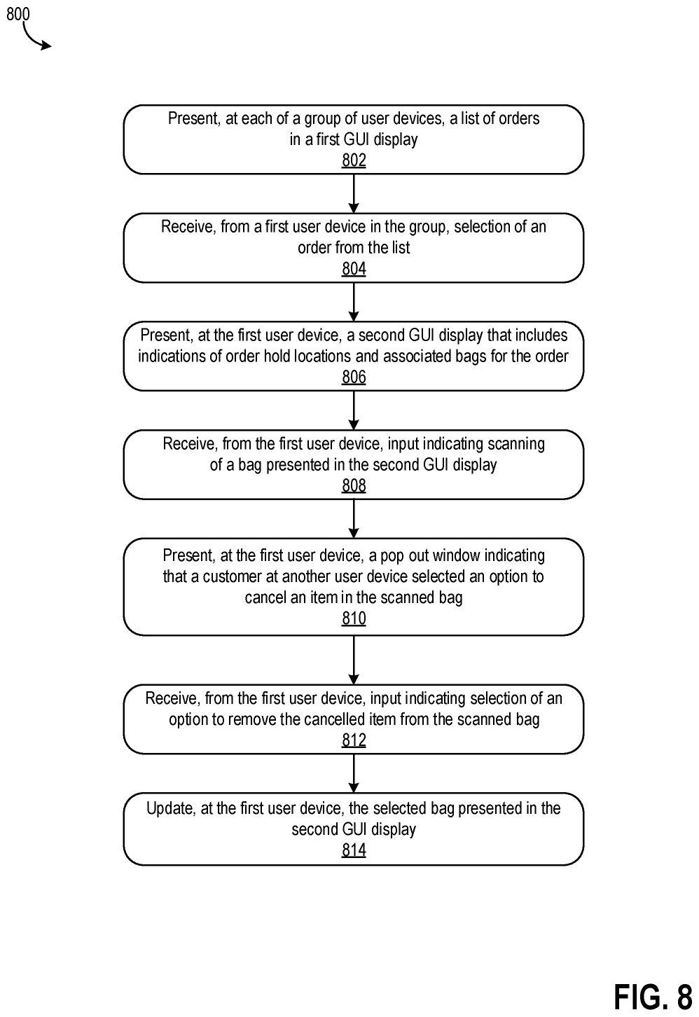

FIG. 8 is a flowchart of a process to be performed by one or more computing devices in a drive-up fulfillment system when a drive-up customer cancels an item in an order. More particularly, the process 800 can be performed when a customer cancels at least one item in their order. The process 800 can be performed by the server system 116 depicted and described in reference to FIG. 1. The process 800 can also be performed by any of the computing devices 118 of employees in the fulfillment location. The process 800 can also be performed by one or more other computing systems, devices, computers, networks, cloud-based systems, and/or cloud-based services. For illustrative purposes, the process 800 is described from the perspective of a server.

Referring to the process 800, the server can present, at each of a group of user devices, a list of orders in a first GUI display in block 802. Refer to the discussion of block 502 in the process 500 of FIG. 5 for additional discussion.

In block 804, the server can receive, from a first user device in the group, selection of an order from the list. As described throughout this disclosure, the first user device may be the same or different than the first user device described in the processes 300, 400, 500, 600, and/or 700 in the respective FIGS. 3, 4, 5, 6, and/or 7. Selection of the order can include clicking or tapping on a customer's name for the order and/or clicking or tapping a control, such as a button, that appears with the order in the list. The control can indicate that the order is ready to be prepped. The control can also indicate that the order is ready to be delivered.

In block 806, the server can present, at the first user device, a second GUI display that includes indications of order hold locations and associated bags for the order. Refer to block 308 in the process 300 of FIG. 3 and block 408 in the process 400 of FIG. 4 for additional discussion about the second GUI display. In some implementations, when an item or items are cancelled by the customer, the bag associated with the cancelled item(s) can be presented in a different indicia. For example, the server can provide, to the first user device, information that, when processed by the first user device, causes the first user device to display a third indicia partially overlaying an indication of a bag of the one or more bags based on a determination, by the server, that an issue exists with an item in the bag. The issue can include at least one of the item being cancelled and/or being recalled. The third indicia can be at least one of a hazard symbol, a triangle, and/or an exclamation point. Refer to FIGS. 2G-K for further discussion about presenting the indication of the bag with the third indicia.

In block 808, the server can receive, from the first user device, input indicating scanning of a bag presented in the second GUI display. Refer to the block 310 described in the process 300 of FIG. 3 for additional discussion about scanning the bag. In some implementations, the block 808 may not be performed. Instead of scanning the bag, the indication of the bag can be represented with the third indicia, such as a hazard symbol. The employee at the first user device can therefore see the third indicia and thus select or click on the indication of the bag having the third indicia.

In block 810, the server can present, at the first user device, a pop out window indicating that a customer at another user device selected an option to cancel an item in the scanned bag. If the employee does not scan the bag and instead clicks on the indication of the bag having the third indicia, the server can still present the pop out window indicating that the customer cancelled the item in the bag having the third indicia.

Next, in block 812, the server can receive, from the first user device, input indicating selection of an option to remove the cancelled item from the scanned bag. Refer to block 712 in the process 700 of FIG. 7 for additional discussion.

The server can then update, at the first user device, the selected bag presented in the second GUI display in block 814. Refer to block 714 in the process 700 of FIG. 7 for additional discussion.

Moreover, refer to FIGS. 2V-Y for additional discussion about the process 800.

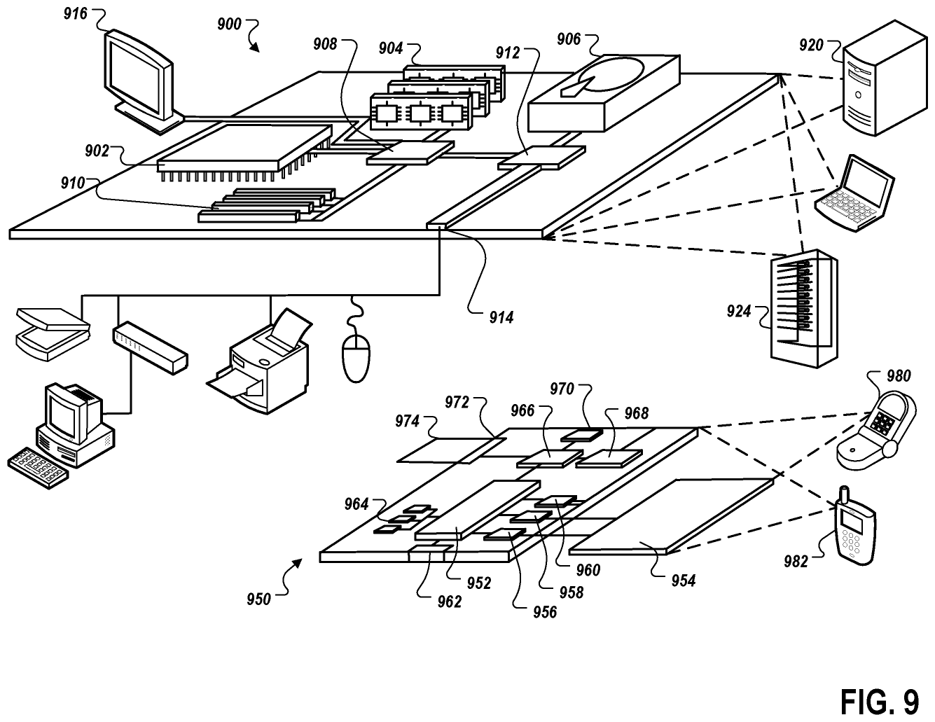

FIG. 9 shows an example of a computing device 900 and an example of a mobile computing device that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method comprising:
providing, by a computing system to each of a plurality of user devices, information that, when processed by each of the plurality of user devices, causes each of the plurality of user devices to display a first graphical user interface (GUI), the first GUI including a list of orders for customers for fulfillment at a fulfillment location;
receiving, by the computing system and from a first user device of the plurality of user devices, user selection of a first control in the first GUI indicating an intention to prepare an order in the list of orders;
providing, by the computing system to at least a subset of the plurality of user devices, instructions to update the first GUI such that the first GUI includes an indication that the order is being prepared;
providing, by the computing system at the first user device in the plurality of user devices, information that, when processed by the first user device cause the first user device to display a second GUI, the second GUI including indications of one or more order hold locations in the retail information and one or more bags associated with each of the one or more order hold locations for the selected order to be prepared;
receiving, by the computing system and from the first user device, information indicating identifying information for one or more of the bags associated with the order;
providing, by the computing system to the first user device, instructions to update the second GUI such that, for each bag associated with the order to be prepared, the indication is updated from a first indicia to a second indicia based on the respective associated bag having been identified by the identifying information and received by the computing system; and
providing, by the computing system to the first user device, instructions to update the second GUI to include a selectable option to complete the preparing of the order based on a determination that the identifying information for each bag associated with the order has been received by the computing system.

2. The method of claim 1, wherein the first indicia is a black bag icon and the second indicia is a green bag icon.

3. The method of claim 1, wherein the indication that the order is being prepared includes an identifier of a user associated with the first user device.

4. The method of claim 1, further comprising:
receiving, by the computing system and from the first user device, an indication of selecting the option to complete the preparing of the order; and
providing, by the computing system to at least the subset of the plurality of user devices, instructions to update the first GUI by removing the order from the list of orders and adding the order to a second list of orders ready to be delivered.

5. The method of claim 1, further comprising:
providing, by the computing system to each of at least the subset of the plurality of user devices, information that, when processed by each of the at least the subset of the plurality of user devices, causes each of the at least the subset of the plurality of user devices to display the first GUI with a list of orders ready to be delivered;
receiving, by the computing system and from a second user device of the at least the subset of the plurality of user devices, an indication of user selection of a second control of the first GUI indicating an intention to deliver a prepared order in the list of orders ready to be delivered; and
providing, by the computing system to each of at least the subset of the plurality of user devices, instructions to update the first GUI to include an indication that the prepared order is being delivered.

6. The method of claim 5, wherein the indication that the prepared order is being delivered includes an identifier for a user associated with the second user device.

7. The method of claim 1, further comprising:
receiving, by the computing system and from the first user device, an indication of user selection of a third control of the first GUI to cancel the preparing of the order; and
providing, by the computing system to the at least the subset of the plurality of user devices, instructions to update the first GUI by replacing the third control to cancel the preparing of the order with the first control to prepare the order.

8. The method of claim 1, wherein the indications of each bag include a numeric value graphically displayed in a bag icon, the numeric value indicating a quantity of items in the bag.

9. The method of claim 1, further comprising:
receiving, by the computing system and from the first user device, an indication of user selection of an indication of a bag of the one or more bags presented in the second GUI;
providing, by the computing system to the first user device, information that, when processed by the first device, causes the first device to display a pop out window that overlays a portion of the second GUI, the pop out window including information about items in the selected bag, wherein the information includes selectable options for completing a hold on the selected bag;
receiving, by the computing system and from the first user device, an indication of user selection of an option from the selectable options to complete the hold on the selected bag; and
providing, by the computing system to the first user device, information that, when processed by the first device, causes the first device to display the selectable option to complete the preparing of the order in the second GUI based on the user selection of the option to complete the hold on the selected bag.

10. The method of claim 1, further comprising providing, by the computing system to the first user device, information that, when processed by the first user device, causes the first user device to display a third indicia partially overlaying an indication of a bag of the one or more bags based on a determination, by the computing system, that an issue exists with an item in the bag.

11. The method of claim 10, wherein the issue includes at least one of the item being cancelled and the item being recalled.

12. The method of claim 10, wherein the third indicia is at least one of hazard symbol, a triangle, and an exclamation point.

13. The method of claim 1, wherein orders in the list of orders for customers for fulfillment at the fulfillment location are ranked and presented in the first GUI from least amount of time remaining before arrival at the fulfillment location to most amount of time remaining before arrival at the fulfillment location.

14. The method of claim 1, wherein the list of orders for customers for fulfillment at the fulfillment location includes a first sub-list of at least one order in the list of orders for customers that arrived at the fulfillment location and a second sub-list of at least one order in the list of orders for customers that are on their way to the fulfillment location.

15. The method of claim 1, wherein the information indicating identifying information for one or more of the bags associated with the order comprises indications for the one or more of the bags that are scanned by the first user device at the fulfillment location.

16. The method of claim 15, wherein the selectable option to complete the preparing of the order is presented in the second GUI and non-selectable until each bag has been scanned.

17. The method of claim 1, wherein the information indicating identifying information for one or more of the bags associated with the order comprises indications for the one or more of the bags that are scanned by a scanning device communicably coupled to the first user device at the fulfillment location.

18. The method of claim 1, wherein the information indicating identifying information for one or more of the bags associated with the order comprises indications for the one or more of the bags that are scanned by a scanning device located at the fulfillment location.

19. The method of claim 1, wherein the information indicating identifying information for one or more of the bags associated with the order comprises alphanumeric identifiers for the one or more of the bags that are inputted by a user at the first user device at the fulfillment location.

20. A system comprising:
one or more processors; and
computer memory containing instructions that, when executed by the one or more processors, cause the system to perform operations comprising:
providing, to each of a plurality of user devices, information that, when processed by each of the plurality of user devices, causes each of the plurality of user devices to display a first graphical user interface (GUI), the first GUI including a list of orders for customers for fulfillment at a fulfillment location;
receiving, from a first user device of the plurality of user devices, user selection of a first control in the first GUI indicating an intention to prepare an order in the list of orders;
providing, to at least a subset of the plurality of user devices, instructions to update the first GUI such that the first GUI includes an indication that the order is being prepared;
providing, at the first user device in the plurality of user devices, information that, when processed by the first user device cause the first user device to display a second GUI, the second GUI including indications of one or more order hold locations in the retail information and one or more bags associated with each of the one or more order hold locations for the selected order to be prepared;
receiving, from the first user device, information indicating identifying information for one or more of the bags associated with the order;
providing, to the first user device, instructions to update the second GUI such that, for each bag associated with the order to be prepared, the indication is updated from a first indicia to a second indicia based on the respective associated bag having been identified by the identifying information and received by the computing system; and
providing, to the first user device, instructions to update the second GUI to include a selectable option to complete the preparing of the order based on a determination that the identifying information for each bag associated with the order has been received by the computing system.
